(19) United States
(12) Patent Application Publication
(10) Pub. No.: US 2012/0262753 A1
(43) Pub. Date: Oct. 18, 2012

(54) PRINT SERVICE IDENTIFICATION

(76) Inventors: Leonardo Davi Viccari, Porto Alegre (BR); Cesar Domingos Job Menon, Porto Alegre (BR); Deny Joao Correa Azzolin, Porto Alegre (BR); Murilo Juchem, Porto Alegre (BR)

(21) Appl. No.: 13/085,211

(22) Filed: Apr. 12, 2011

(51) Int. Cl. G06K 15/00

(52) U.S. Cl. 358/1.15

(57) ABSTRACT

Print services are identified. For example, a particular print services provider for handling a print job for a particular client computing device may be identified from among multiple different print services providers, each of which may offer one or more print services for printing content. Thereafter, a specific print service offered by one of the particular print services providers may be identified as being relevant to a print service search query from the particular client computing device.

### BACKGROUND

A printer converts electronic content into hardcopy form, for example on physical print media such as paper.

### BRIEF DESCRIPTION OF THE DRAWINGS

FIG. 1 is a block diagram of an example of a communications system.

FIGS. 2A-2E are diagrams of an example electronic device.

FIG. 3 is a flowchart of an example of a process for assigning an identifier to a client.

FIGS. 4 and 5 are flowcharts of examples of processes for handling print job requests.

FIG. 6 is a flowchart of an example of a process for identifying a relevant print service.

### DETAILED DESCRIPTION

A print services directory service stores or otherwise has access to information about a variety of different print services providers. These print services providers may include a wide number of different types of print services providers. Some of the print services providers may be retail office services businesses with multiple locations (e.g., brick and mortar stores, kiosks, etc.) providing computing and/or printing services. Other of the print services providers may be enterprise businesses that provide printers within their information technology (IT) infrastructure for use by employees to print content related to their job functions. Still other of the print services providers may be standalone printers, such as, for example, personal printers located in individuals' homes.

The print services directory service may use the information about the variety of different print services providers to help a user identify print services providers that may be relevant to a print job that the user desires to complete. In this regard, the print services directory service may be especially helpful for an “on-the-go” user of a mobile computing device (e.g., a smartphone or tablet computer) seeking to locate a printer at which to print content in an environment in which the user is not necessarily familiar.

Among the information stored by or accessible to the print services directory service may be authorization information defining specific client applications and/or users who are authorized to utilize the various different print services providers. For example, an enterprise business may make a client application available to employees' mobile computing devices to enable the employees to print content from their mobile devices at any of a number of different printers on the enterprise business' IT infrastructure. In such implementations, the information stored by or accessible to the print services directory service for the enterprise business may specify that access to the printers on the enterprise business' IT infrastructure is limited to mobile devices executing the enterprise business' client application.

In addition, the information stored by or accessible to the print services directory service also may include information about the print services provided by the various different print services providers (e.g., location(s), costs, capabilities, etc.). Thus, the print services directory service may be able to help a user identify print services providers that the user is authorized to utilize as well as individual print services provided by the different print services providers the user is authorized to utilize that may be relevant to a print job the user desires to complete. For example, the print services directory may be able to help an “on-the-go” user of a mobile device identify a print services provider that the user is authorized to utilize and a location of a print service provided by the print services provider that is convenient to the user's current location.

The print services directory service may expose an application programming interface (API) to remote computing devices to enable applications executing on such remote computing devices to access the print services directory service. As such, numerous different types of applications executing on remote computing devices may be able to access the services provided by the print services directory service. For example, an e-mail application for a mobile computing device may be able to access the services provided by the print services directory service to enable users to print e-mails and/or attachments received on their mobile computing devices. Likewise, a word processing application for a mobile computing device may be able to access the services provided by the print services directory service to enable users to print documents they have edited or accessed on their mobile computing devices.

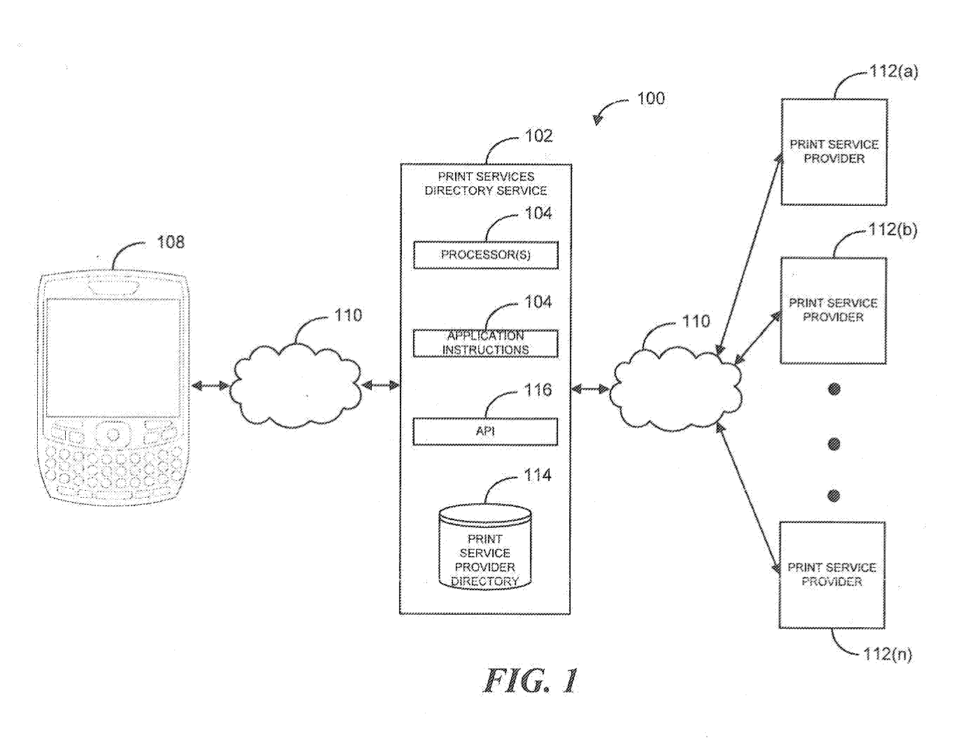

FIG. 1 is a block diagram of an example of a communications system 100 within which a print services directory service 102 is implemented. For illustrative purposes, several elements illustrated in FIG. 1 and described below are represented as monolithic entities. However, these elements each may include and/or be implemented on numerous interconnected computing devices and other components that are designed to perform a set of specified operations and that are located proximally to one another or that are geographically displaced from one another.

Print services directory service 102 may be implemented by one or more computing devices (e.g., servers), each of which includes one or more processors 104 for executing instructions. The one or more computing devices on which print services directory service 102 is implemented each also may have internal or external storage components storing data, an operating system, and executable instructions 106 that, when executed by processor(s) 104, cause the computing device(s) to provide the print services directory service functionality ascribed herein to print services directory service 102. In addition, the one or more computing devices also typically include network interfaces and communication devices for sending and receiving data.

Print services directory service 102 is accessible to other remote computing devices, such as, for example, mobile computing device 108, via network 110. In addition, print services directory service 102 also has access to multiple different print services providers 112 via network 110.

Mobile computing device 108 may be any of a number of different types of mobile computing devices including, for example, a smartphone, a personal digital assistant, a portable media player, a mobile phone, a laptop computer, a tablet computer, or a netbook computer. Mobile computing device 108 typically has internal or external storage components for storing data and programs such as an operating system and one or more application programs. Examples of application programs include authoring applications (e.g., word processing programs, database programs, spreadsheet programs, or graphics programs) capable of generating documents or other electronic content; client applications (e.g., e-mail clients) capable of communicating with other computer users, accessing various computer resources, and viewing, creating, or otherwise manipulating electronic content; and browser applications capable of rendering Internet content.

Mobile computing device 108 also typically includes a central processing unit (CPU) for executing instructions stored in storage and/or received from one or more other electronic devices, for example over network 110. In addition, mobile computing device 108 also usually includes one or more communication devices for sending and receiving data. Examples of such communications devices include modems, antennas, transceivers, communications cards, and other types of network adapters capable of transmitting and receiving data over network 110 through a wired or wireless data pathway.

In some cases, an application that coordinates with other applications (e.g., e-mail applications, authoring applications, browser applications, etc.) executing on mobile computing device 108 and that enables such other applications to access services provided by print services directory service 102 to print content may be executing on mobile computing device 108. Additionally or alternatively, an e-mail application, an authoring application, and/or a browser application executing on mobile computing device 108 may be configured to access services provided by print services directory service 102 without need for an intermediary application executing on mobile computing device 108 to coordinate with print services directory service 102.

Although FIG. 1 illustrates a mobile computing device 108 accessing print services directory service 102 to leverage services provided by print services directory service 102, any type of computing device may be able to access print services directory service 102, including computing devices not traditionally considered to be mobile computing devices (e.g., desktop computers).

Network 110 may provide direct or indirect communication links between mobile computing device 108 and print services directory service 102 as well as between print services directory service 102 and the different print services providers 112. Examples of network 110 include the Internet, the World Wide Web, wide area networks (WANs), local area networks (LANs) including wireless LANs (WLANs), analog or digital wired and wireless telephone networks, radio, television, cable, satellite, and/or any other delivery mechanisms for carrying data.

Print services providers 112 may include a wide variety of different types of print services providers. Some of print services providers 112 may be regional, national, or international chains having multiple different retail locations that provide printing capability. For example, some of print services providers 112 may have multiple brick and mortar stores, each of which may have multiple printers available for printing content. Additionally or alternatively, some of print services providers 112 may have multiple print kiosks in different public locations (e.g., shopping malls, hotels, airports, train stations, etc.) that provide printing capability. In such cases, print services directory service 102 may not communicate directly with individual printers made available by such print services providers 112. Instead, print services directory service 102 may communicate with applications running on computing devices exposed by the print services providers 112 for the purposes of communicating with print services directory service 102 and other applications and for handling print job intake over network connections, such as, for example network 110. For example, such a print services provider may expose an on-line service that enables users or other services (e.g., print services directory service 102) to submit print jobs to be fulfilled by any one of the printers operated by the print services provider 112. The print services provider 112 then may handle the processing and routing of the print job to ensure that it is fulfilled by an appropriate one of the printers operated by the print services provider 112. Other of print services providers 112 may be private businesses having printers as part of their IT infrastructures so as to enable employees to be able to print content related to their job functions. Still other of print services providers 112 may be standalone printers (e.g., personal home printers) that are not affiliated with any professional or business enterprise, but that are network-connected and accessible to print services directory service 102 via network 110.

Print services directory service 102 is implemented on one or more computing devices by processors 104 executing instructions 106. The one or more computing devices on which print services directory service 102 is implemented include additional storage components storing a print services provider directory 114.

Print services provider directory 114 stores information about print services providers 112. In some implementations, print services provider directory 114 may store information relevant to individual print services providers 112 in corresponding individual directories and sub-directories. Within the directory or sub-directory for any given print services provider 112, print services provider directory 114 may store information about individual print services provided by the print services provider 112. In some cases (e.g., for a print services provider 112 that is an office services chain having multiple different retail locations each of which may have multiple different printers), the individual print services may correspond to the different retail locations of the print services provider. In other cases, the print services may correspond to specific, individual printers.

Print services provider directory 114 may store information about the number, types, and capabilities of different printers/print services provided by each of print services providers 112. In addition, print services provider directory 114 may store information about the different locations where the different print services providers 112 provide printing capability and/or print services provider directory 114 may store information about fees charged by the different print services providers 112 for printing content. Additionally or alternatively, print services provider directory 114 may store information about users and/or client applications that are authorized to access individual ones of the print services providers 112 and/or information about users and/or client applications that are not authorized to access individual ones of the print services providers 112.

Print services directory service 102 exposes an API 116 to enable applications executing on other computing devices (e.g., mobile computing device 108) to interface with and leverage the services provided by print services directory service 102. In some implementations, application instructions 106 and API 116 may be implemented as separate modules. In other implementations, API 116 may be implemented by or as a component of application instructions 106.

Print services directory service 102 is configured to coordinate with applications executing on remote computing devices (e.g., mobile computing device 108) to identify print services providers 112 for handling print jobs for the remote computing devices.

In one implementation, an application executing on mobile computing device 108 issues a request to print services directory service 102 to identify print services providers 112 to handle a print job for mobile computing device 108. In response, print services directory service 102 may access print services provider directory 114, and identify particular ones of print services providers 112 that the application executing on mobile computing device 108 is authorized to leverage.

Thereafter, the application executing on mobile computing device 108 may issue a request to print services directory service 102 to search one or more of the print services providers 112 that the application executing on mobile computing device 108 is authorized to leverage for specific print services that are relevant to a print job. For example, the application executing on mobile computing device 108 may provide information about the current location (e.g., location coordinates) of mobile computing device 108 and/or one or more keywords to the print services directory service 102 and request that the print services directory service 102 search the selected print services providers 112 that the application executing on mobile computing device 108 is authorized to access for specific print services that are convenient to the current location of the mobile computing device 108 and/or that are relevant to the keywords.

After print services directory service 102 has identified one or more particular print services for the application executing on mobile computing device 108 in this fashion, print services directory service 102 may coordinate the uploading of the content to be printed from mobile computing device 108 to print services directory service 102 as well as the transfer of the content to be printed from print services directory service 102 to a particular print service for fulfillment. Alternatively, print services directory service 102 may arrange for the transfer of the content to be printed from the mobile computing device 108 to the particular print service without the content to be printed ever being uploaded to the print services directory service 102. For example, print services print directory service 102 may provide the application executing on mobile computing device 108 with an e-mail address for the particular print service to which the content to be printed can be sent for fulfillment.

In some implementations, the printers made available by the various different print services providers 112 may reside on private networks (e.g., networks maintained by their corresponding print services providers 112) or otherwise may not be directly accessible to mobile computing device 108. For example, firewalls or other security mechanisms may block access to the printers by mobile computing device 108. As such, print services directory service 102 may function both to identify print services for mobile computing device 108 as well as to provide mobile computing device 108 with access to printers that otherwise may not be accessible to mobile computing device 108.

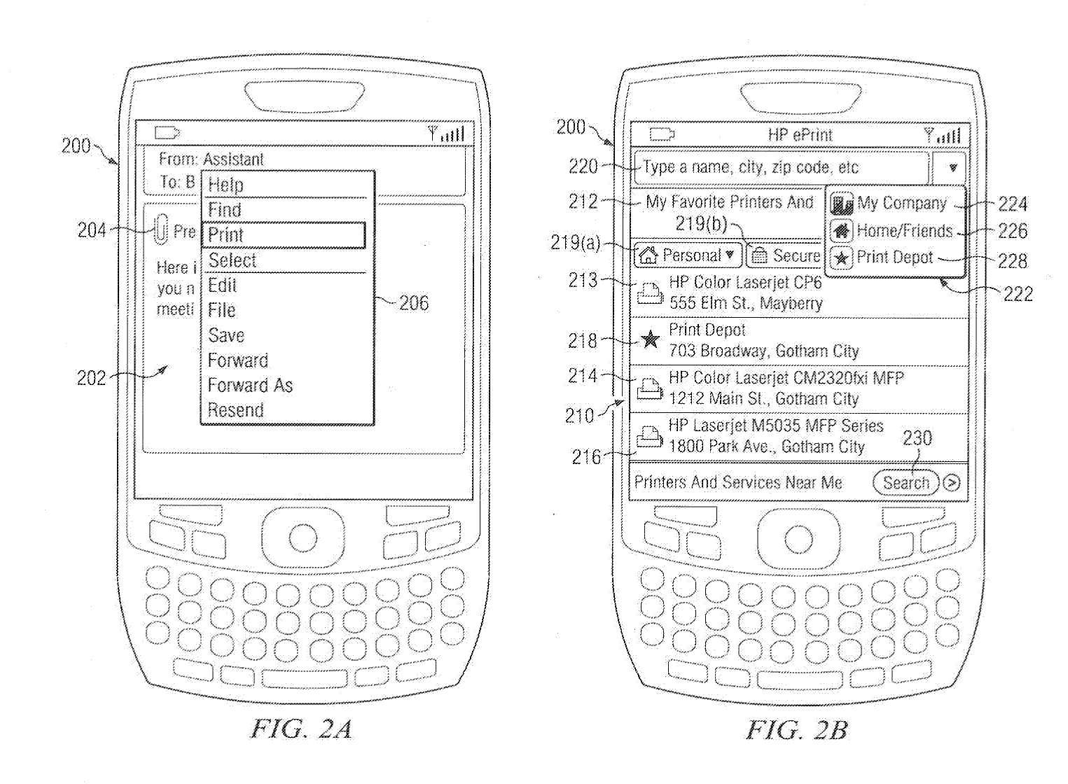

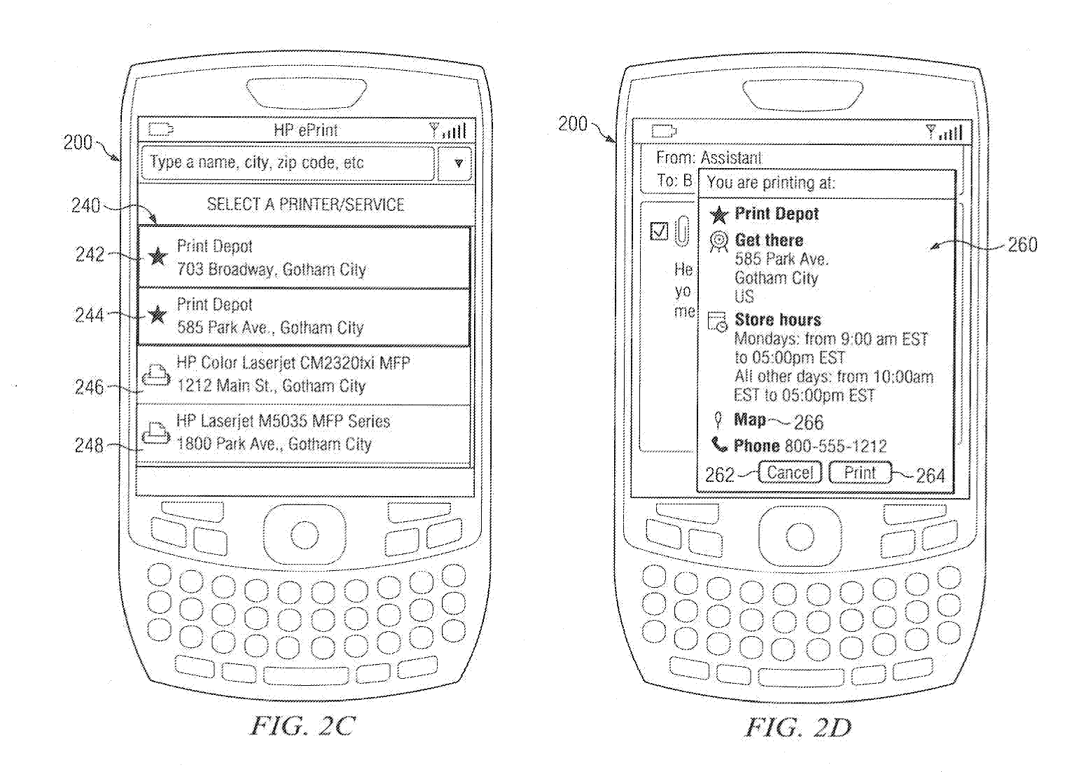

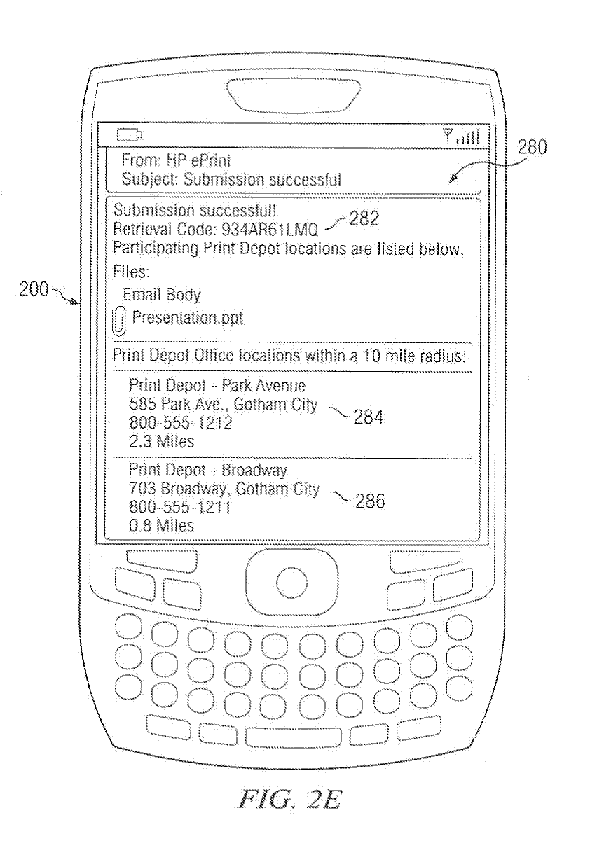

FIGS. 2A-2E are diagrams of an example mobile computing device 200 that illustrate one example of a user experience for using the mobile computing device to interface with an on-line print services directory service (e.g., print services directory service 102 of FIG. 1) to locate and thereafter utilize a relevant print service. As illustrated in FIG. 2A, the mobile computing device 200 is executing an e-mail client application, and the user of the mobile computing device 200 is using the mobile computing device 200 to view an e-mail 202 that includes an attachment 204. In addition, the user of the mobile computing device 200 has used an input mechanism provided by the mobile computing device 200 to surface a menu 206 within the e-mail client application that provides different options for actions to take in connection with the e-mail 202. As illustrated in FIG. 2A, the user of the mobile computing device 200 has used an input mechanism provided by mobile computing device 200 to cause the mobile computing device 200 to select the print option from within the menu 206, thereby indicating a desire to print the e-mail 202 and/or the attachment 204.

Referring now to FIG. 2B, in response to the selection of the print option from within menu 206, the mobile computing device 200 surfaces a print interface 210. The print interface 210 includes a list 212 of individual printers 213, 214, and 216 and/or print services 218 identified as “Favorite Printers and Services.” the mobile computing device 200 may have identified individual printers 213, 214, and 216 and/or print services 218 for inclusion within the list of “Favorite Printers and Services” based on previous usage (e.g., relatively recent or relatively frequent usage) by the mobile computing device 200 to fulfill print requests initiated by the mobile computing device 200. As such, the individual printers 213, 214, and 216 and/or print service 218 listed within the list 212 of “Favorite Printers and Services” may have been identified for inclusion within the list 212 of “Favorite Printers and Services” without or irrespective of the user of mobile device 200 having supplied desired attributes of a printer or print service to be used to fulfill the print job. Furthermore, information about the individual printers 213, 214, and 216 and/or print service 218 listed within the list 212 of “Favorite Printers and Services” may have been pulled from the print services directory service without or irrespective of the user of mobile device 200 having requested information about the individual printers 213, 214, and 216 and/or print service 218.

As illustrated in FIG. 2B, the list of “Favorite Printers and Services” includes an individual printer 213 located in Mayberry, two individual printers 214 and 216 located at different addresses in Gotham City, and a print service, “Print Depot,” 218 located in Gotham city. “Print Depot” may be a retail office services chain having multiple different locations that offer printing services for customers. The specific “Print Depot” location 218 listed in list 212 may offer a number of different types of printers, some having different capabilities, for use by customers to print documents. Each of these different printers at “Print Depot” 218 may be available to the user of the mobile computing device to print the e-mail 202 and/or the attachment 204 even though the “Print Depot” listing 218 does not identify those printers individually.

The individual printers 213, 214, and 216 and print service 218 listed in the “Favorite Printers and Services” list 212 may operate as shortcuts for the user to instruct that a particular one of the individual printers 213, 214, and 216 or print service 218 is to be used to fulfill the print request. That is to say, print interface 210 may enable a user of mobile device 200 to instruct that a particular one of the individual printers 213, 214, and 216 or print service 218 is to be used to fulfill the print request by selecting the particular printer or print service from the “Favorite Printers and Services” list 212.

Print interface 210 also includes “Personal” and “Secure” accelerator buttons 219(a) and 219(b), respectively. “Personal” and “Secure” buttons 219(a) and 219(b) correspond to printers or print services that were identified for the user of mobile device 200 by the e-mail client application in conjunction with the print services directory service without or irrespective of the user of mobile device 200 having supplied desired attributes of a printer or print service to be used to fulfill the print job, for example based on pre-existing knowledge of personal printers of the user of the mobile device 200 and/or secure printers made available to the user of the mobile device 200 by the user's employer. Selection of one of the “Personal” and “Secure” accelerator buttons 219(a) and 219(b) may cause the print job to be completed by a printer or print service corresponding to the selected accelerator button without further interaction by or involvement from the user of mobile device 200.

Print interface 210 also includes a search term entry field 220 configured to receive search terms from the user of mobile computing device 200 to be used to identify candidate printers and/or print services to use to fulfill the print request. Therefore, in the event that the user of the mobile computing device 200 is not interested in using one of the individual printers 213, 214, and 216 or print service 218 to fulfill the print request, the user of the mobile computing device 200 can enter search terms into search term entry field 220 to identify candidate print services to be used to fulfill the print request. For example, the user of the mobile computing device 200 may enter search terms that are relevant to the user's current location into search term entry field 220 or, instead, the user of the mobile computing device 200 may enter search terms that are relevant to a destination to which the user is traveling and at which the user desires to retrieve the completed print job.

Search term entry field 220 may be configured to receive one or both of specific address information (e.g., street address, city, and/or zip code) and more general location information (e.g., landmark-based location information such as “Empire State Building”). Additionally or alternatively, the user of mobile computing device 200 also may enter search terms related to printer capabilities that the user of mobile computing device 200 desires the printer that is used to fulfill the print job to have. For example, if the content to be printed includes a photograph, the user of mobile computing device 200 may enter the term “photograph,” among others, in search term entry field 220.

Print interface 210 also includes drop-down filter menu 222 that enables a user of mobile computing device 200 to specify certain directories of available print services to which the search for a relevant print service should be limited. For example, as illustrated in FIG. 2B, drop-down filter menu 222 enables a user of mobile computing device 200 to specify that the search for a relevant service should be limited to print services available from the user's employer, print services owned or operated by the user or the user's friends, and/or print services available from the “Print Depot” print services provider by selecting one or more of graphical components 224, 226, and 228, respectively.

The print services providers listed in drop-down menu 222 may be populated based on print services providers that the e-mail client application and/or the user of mobile computing device 200 are authorized to utilize. For example, after receiving the user's selection of the print option from within menu 206 as illustrated in FIG. 2A, the e-mail client application may issue a request to the print services directory service to identify print services providers that are available to fulfill print requests initiated from the e-mail client application based upon the e-mail client application itself and/or the identity of the user of the mobile computing device 200. The print services directory service then may respond with information about print services providers that are available to fulfill print requests initiated from the e-mail client application, and the e-mail client application may use this information to populate the drop down filter menu 222 with the available print services providers. In the event that the user of mobile computing device 200 does not select any of the available print services providers listed within drop-down filter menu 222, the default may be for searches to be performed against all print services providers available to fulfill print requests initiated from the e-mail client application (e.g., all print services providers that the e-mail client application and/or the user of the mobile computing device 200 are authorized to utilize).

Print interface 210 also includes a selectable search control 230 that, when actuated, causes the e-mail client application to generate and transmit a search request to the print services directory service to identify candidate print services perceived as being relevant to the print job to be fulfilled. When the user of the mobile computing device 200 has entered search terms into search term entry field 210, those search terms may be included within the search request transmitted to the print services directory service for searching against the available print services providers. Additionally or alternatively, mobile computing device 200 may be global positioning system (GPS)-equipped, and the current geographic coordinates of the mobile computing device 200, as determined by the GPS capability of the mobile computing device 200, may be included within the search request.

The print services directory service may receive the search request from the e-mail client application executing on the mobile computing device 200 and use the information included within the search request to identify candidate print services to be used to fulfill the print request. The print services directory service then may issue a response to the e-mail client application that includes information about one or more of the print services provided by the available print services providers that were identified as being candidates for fulfilling the print request. The e-mail client application then may use the information received in the response from the print services directory service to generate a menu of available print services from among which the user of mobile computing device 200 can select a particular print service to use to fulfill the print request.

For example, referring now to FIG. 2C, the mobile computing device 200 is displaying a print services selection menu 240 listing two print services 242 and 244 and two individual printers 246 and 248, all of which are located within the same city. As illustrated in FIG. 2C, two different retail locations 242 and 244 of the “Print Depot” print services provider are listed in print services selection menu 240 as being candidates for fulfilling the print request. Furthermore, both of these listings 242 and 244 are highlighted within print services selection menu 240. This may be due to the fact that the “Print Depot” print services provider has a special partnership agreement in place with the print services directory service and so, as part of the response to the search request issued to the mobile computing device 200, the print services directory service indicated that the two “Print Depot” listings should be displayed prominently in the print services selection menu 240. In some implementations, the ordering of the individual listings 242, 244, 246, and 248 may be based on the perceived relevance of each of the print services to the print request. Additionally or alternatively, the ordering of the individual listings 242, 244, 246, and 248 may be based on the partnership agreements the print services directory service has with different print services providers (e.g., print services providers with premium partnerships with the print services directory service may be displayed before print services providers with standard partnerships with the print services directory service).

The individual listings 242, 244, 246, and 248 included within print services selection menu 240 may be selectable such that the user of mobile computing device 200 can select a particular one of the individual listings 242, 244, 246, and 248 from within print services selection menu 240 in order to instruct the e-mail client application to use the selected print service to fulfill the print request. In response to receiving such a selection from the user of mobile computing device 200, the e-mail client application may cause the mobile computing device 200 to display a print confirmation interface requesting that the user confirm that the selected print service is the print service to be used to fulfill the print request and providing additional information about the selected print service.

For example, referring to FIG. 2D, mobile computing device 200 is displaying a print confirmation interface 260 that includes selectable controls 262 and 264 for cancelling and confirming the print request, respectively, as well as the street address, telephone number, and store hours for the selected “Print Depot” location. In addition, print confirmation interface 260 also includes a selectable link 266 that, when selected, may trigger the display of a mapping application that may help to identify directions from the current location of the mobile computing device 200 to the selected “Print Depot” location. In some implementations, the information displayed in the print confirmation interface 260 may have been transmitted to the mobile computing device 200 by the print services directory service as part of the response to the search request issued by the print services directory service. However, the e-mail client application may not cause this additional, more detailed information about the selected print service, to be displayed until after the print service has been selected as the print service to be used to fulfill the print request.

As discussed above, user selection of print control 264 may operate as confirmation that the selected “Print Depot” location is to be used to process the print request and, therefore, trigger the transmission of a process print request from the e-mail client application to the print services directory service requesting the print services directory service to process the print request at the selected “Print Depot” location. In some implementations, before processing the print request, the e-mail client application may query the user of mobile computing device 200 to determine whether the user desires to print the body of the e-mail 202, the attachment 204, or both.

Upon receiving the process print request, the print services directory service then may coordinate with the selected print service to process the print request. In some cases, processing the print request may include the actual printing of the content. In other cases, processing the print request may involve transferring the content to the selected print service (or the print services provider that offers the selected print service) for later printing.

After the process print request has been processed successfully, the print services directory service may transmit a response to the e-mail client application that confirms that the print request was processed successfully and that may provide a release code to be used to retrieve the printed documents.

Additionally, in some implementations, the response from the print services directory service to the e-mail client application may include additional information about the print service selected to process the print request. Furthermore, in some implementations, when the print service selected to process the print request belongs to a print services provider having multiple locations and/or print services and the processing of the print request involved transfer of the content to be printed to the print services provider by not the actual printing of the content, the message transmitted to the e-mail client application may provide information about other print services and/or locations of the print services provider that may be of interest to the user so that the user can opt for a different print service or location of the print services provider at which to fulfill the request.

Upon receipt of the successful print processing confirmation message from the print services directory service, the e-mail client application may cause the mobile computing device 200 to display a confirmation message. For example, referring to FIG. 2E, the mobile computing device 200 is displaying a confirmation message 280 that has been formatted by the e-mail client application to appear as an e-mail within the e-mail client application's e-mail inbox. The message 280 confirms that the print request has been submitted successfully and includes an indication of a release code that may be used to retrieve the printed documents. In addition, the message 280 includes information about the selected “Print Depot” service 248 and an alternative “Print Depot” service 286. In this case, it may be possible for the user of mobile computing device 200 to travel either the selected “Print Depot” service 284 or the alternative “Print Depot” service 286 and retrieve the printed documents by providing the release code 282.

Referring again to FIG. 1, print services directory service 102 may be configured to communicate with client applications executing on remote computing devices (e.g., mobile computing device 108) according to the hypertext transfer protocol (HTTP). For example, in order for print services directory service 102 to provide services to a client application executing on mobile computing device 108, an HTTP session may be established between the client application executing on mobile computing device 108 and print services directory service 102 such that the client application sends HTTP request messages to the print services directory service 102 to which the print services directory service 102 issues HTTP response messages in reply.

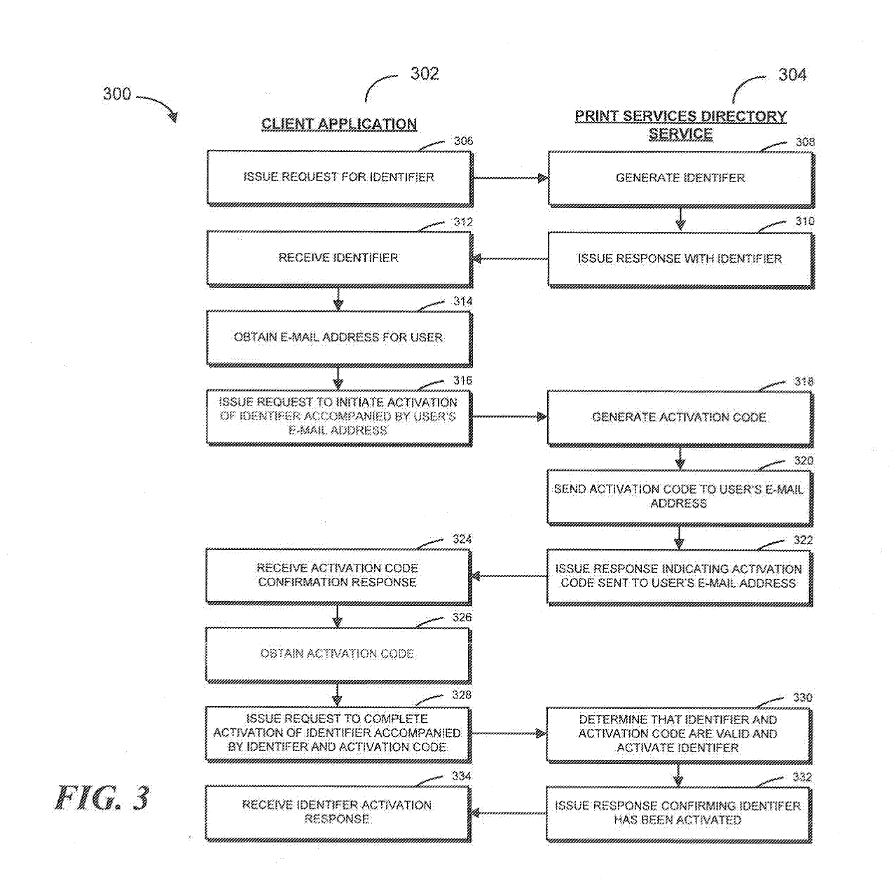

FIGS. 3-5 are flowcharts of examples of different processes that involve the exchange of communications between a client application (e.g., a client application executing on a mobile computing device like mobile computing device 108 of FIG. 1) and a print services directory service (e.g., print services directory service 102 of FIG. 1). In some implementations, the HTTP protocol may be employed to handle the exchange of such messages, with messages sent by the client application being HTTP requests, and reply messages sent by the print services directory service being HTTP responses. Therefore, although different formatting and syntaxes and, indeed, different networking protocols may be employed to accomplish the exchange of messages illustrated in FIGS. 3-5, example formats and syntaxes for such HTTP requests and responses will be provided throughout the discussion of FIGS. 3-5 for illustrative purposes.

An HTTP request issued by the client application may use regular URL paths and take an HTTP header/body form. In addition, an HTTP request issued by the client application may include the request headers outlined in Table 1 below:

TABLE 1

| Header | Description |
|---|---|
| X-ePrint-UserTag | Specifies an ID assigned to a user and/or |
| | particular device. |
| User-Agent | A header in the following format “app_id/ |
| | profile/pin/version,” where: |
| | App_id specifies an ID assigned to the client |
| | application issuing the request; |
| | Profile specifies a semicolon-separated set of |
| | values: |
| | MAKE_AND_MODEL; OS_VERSION; |
| | WIDTH × HEIGHT; COUNTRY_CODE; |
| | RADIO_TYPE; |
| | CUSTOM1; CUSTOM2 |
| | MAKE_AND_MODEL: specifies device |
| | manufacturer and model name; |
| | OS_VERSION: specifies device's operating |
| | system version; |
| | WIDTH × HEIGHT: specifies device screen size |
| | in pixels (e.g., for portrait orientation); |
| | COUNTRY_CODE: specifies country code for |
| | location; |
| | RADIO_TYPE: specifies device antenna type: |
| | Pin specifies the pin number of the device or any |
| | arbitrary and unique string; and |
| | Version specifies a string representing the current |
| | version of the client application (e.g., in the |
| | format major.minor.micro). |
| Accept-Language | Specifies a preferred locale (e.g., as ISO or java |
| | code) for any string provided by print services |
| | directory service. |
| X-ePrint-ApiVersion | Specifies the API version supported by the client |
| | application. |
| X-ePrint-Location | Specifies the device's current latitude, longitude, |
| | and/or horizontal accuracy (e.g., represented as |
| | latitude/longitude/accuracy). |
| Cookie | Specifies a cookie value for HTTP session |
| | tracking. |
| From | Specifies an e-mail address of the user of the |
| | client application. |

An HTTP response issued by the print services directory service may return an HTTP code reflecting a general status of the print services directory service and/or the specific transaction requested as outlined in Table 2 below:

TABLE 2

| HTTP Code | Description |
|---|---|
| 200 | Transaction was successful. Body may have a response |
| | envelope containing objects. |
| 201 | Transaction was successful and requested entity was |
| | successfully created. Body may have a response envelope |
| | containing objects. |
| 301 | Redirection of service URL. |
| 400 | Malformed service URL (either URL or get/post parameters |
| | are not conformant to API or have invalid values). |
| | Envelope header may contain messages stating the nature |
| | of error. |
| 401 | UserTag needs to be activated. |
| 403 | UserTag or app_id not authorized. Envelope header might |
| | contain extended information. |
| 404 | Request of an unknown resource (e.g., service, directory |
| | or graphic not found). |
| 405 | Request of an unknown method (e.g., method or transaction |
| | does not exist). |
| 500 | General system error. |
| 501 | Transaction not executed due to a temporary error |
| | condition. |
| 503 | Service is running but suspended and not offering any |
| | transactions. |

In addition, the HTTP response may take the form of a response envelope having a header and a body formatted as an extensible markup-language (XML) fragment as illustrated in the example snippet below:

<response>

<header queryTime=“PROCESSING_TIME”
version=“API_VERSION”>

<status>

```
  <code>STATUS_CODE</code>
  <severity>SEVERITY_CODE</severity>
  <message>MESSAGE_STRING</message>
```

<optionalMessage>MESSAGE_STRING</optionalMessage>

</status>
<general>

<info>

<type>INFO_TYPE</type>
<data>STRING</data>
<display>STRING</display>

</info>

</general>

</header>
<body>...</body>

</response>

In this example, PROCESSING_TIME may provide the server time (in milliseconds) to process the request and API_VERSION may be a string specifying the API version used to respond to the request (e.g., in major.minor.micro format). In addition, STATUS_CODE may specify a status for the requested transaction and/or a general condition of the print services directory service as outlined in Table 3 below:

TABLE 3

| Status Code | Description |
|---|---|
| 0 | Request was processed with no errors. |
| 1 | User not authorized. |
| 2 | Target service/device is not available (e.g., offline or not |
| | found). |
| 3 | Server error. |
| 4 | Server is not accepting requests. |
| 5 | Server was discontinued. |
| 6 | Server timeout. |
| 7 | Request is invalid or entity was not found. |
| 8 | Redirection requested. |
| 9 | Service/device was reset. (E.g., cache may need to be |
| | refreshed.) |
| 10 | UserTag must be activated. |
| 11 | app_id is not authorized. |
| 12 | Request not allowed |
| 13 | Password invalid. |
| 14 | Authentication reset required. |

Furthermore, SEVERITY_CODE may specify information intended to help the client application display data according to criticality as outlined in Table 4 below:

TABLE 4

| Severity Code | Description |
|---|---|
| 0 | Not relevant. |
| 1 | Informative. |
| 2 | Warning, temporary condition. |
| 3 | Fatal error. |

Also, the info tags may specify extended information or request actions to be performed by the client application as outlined in Table 5 below:

TABLE 5

| Info Type | | Data Tag | Display |
|---|---|---|---|
| Value | Description | Value | Tag Type |
| 1 | General message. String in display | | String |
| | tag should be displayed. | | |
| 3 | If data tag is empty, client | Empty, or | String |
| | application should erase persistent | a service | |
| | service/device cache. | ID | |
| | If data tag holds a service ID, | | |
| | client application should erase the | | |
| | indicated service from persistent | | |
| | service cache. | | |
| | If display tag is present, string in | | |
| | display tag should be displayed. | | |
| 4 | The URL specified in the data tag is | URL | |
| | a new base URL for the printer | | |
| | services directory service that may | | |
| | be used for future requests. | | |
| 10 | New UserTag, already activated. | UserTag | |
| | Client application should silently | | |
| | persist the UserTag for inclusion | | |
| | as X-ePrint-UserTag header on | | |
| | request headers. | | |
| 11 | New UserTag, not activated. | UserTag | |
| | Client application should silently | | |
| | persist the UserTag for inclusion | | |
| | as X-ePrint-UserTag header on | | |
| | request headers. | | |
| 12 | Password set. Client application | | |
| | should obtain user's password | | |
| | before requesting job-related | | |
| | transactions. | | |

In some implementations where a print services provider available to the client application corresponding to a printing resource made available to the client application by an enterprise business to enable employees of the enterprise business to enable employees of the enterprise business to print content using printers available on the enterprise business' IT infrastructure from detached devices, the print services directory service may facilitate the identification of secure pull print services provided by the enterprise business. As illustrated in the sample snippet below, in such implementations, an HTTP response issued by the print services directory service may specify information about such secure pull print queues in the response header to inform the client application of the existence of the secure pull print queues without requiring the client application to search for them:

<general>

<info>

<type>INFO_TYPE</type>
<data>STRING</data>
<display>STRING</display>

</info>

<secure>

<item id=″0″ host=″host.net″ hash=”NUMBER”
account=″account@host.net″ >Queue Name</item>

...

</secure>

</general>

In this example, id may be a printer ID for one of the enterprise business' printers (or print services), host and account may be entry points to address the secure pull print queue on a multi-node scenario, and hash may be a checksum to ensure that the client application transacts with up-to-date entities on the enterprise business' network. In addition, the text part of the item tag may hold a descriptive name for the enterprise business' printer (or print service).

In addition to the above, an HTTP response issued by the print services directory service may include the response headers outlined in Table 6 below:

TABLE 6

| Header | Description |
|---|---|
| Set-Cookie | Requests that the client application store a cookie |
| | (e.g., given cookie name and time-to-live) in order |
| | to track HTTP sessions. |
| WWW-Authenticate | Specifies activation is necessary for a specific realm. |
| Content-Language | Specifies the ISO language code used to return |
| | messages for the request. |
| Server | Specifies the server hostname used to respond to the |
| | request. |
| Location | Specifies a new base URL for the service when the |
| | service is permanently redirected. |

In some implementations, before a client application executing on a client device can access and leverage the services provided by the print services print directory, the client application may need to acquire an identifier. In some such implementations, this identifier may represent the client application itself. In other such implementations, this identifier may represent a user of the client application or the device on which the client application is executing.

FIG. 3 is a flowchart 300 of an example of a process for assigning an identifier to a client application. The process illustrated in the flowchart 300 of FIG. 3 may be performed by a client application 302 executing on a computing device (e.g., mobile computing device 108 of FIG. 1) in conjunction with print services directory service 304 (e.g., print services directory service 102 of FIG. 1). In particular, the process illustrated in the flowchart 300 of FIG. 3 may be implemented by one or more processors of mobile computing device 108 and one or more processors 104 of the one or more computing devices on which print services directory service 102 is implemented as a consequence of executing instructions 106 stored on computer-readable storage media accessible to mobile computing device 108 and instructions stored on computer-readable storage media accessible to print services directory service 102 respectively.

At 306, client application 302 issues a request for an identifier. Continuing with the HTTP request-response example introduced above, this request may be a request for a UserTag and it may take the form “PUT at <BASE_URL>/auth/.” In addition, this request may include the HTTP request headers discussed above, where <BASE_URL> is the base uniform resource locator (URL) for the print services directory.

At 308, after receiving the request from client application 302, print services directory service 304 generates the requested identifier. Thereafter, at 310, print services directory service 304 issues a response to client application 302 with the requested identifier. Continuing with the HTTP request-response example, this response may indicate an HTTP status of “201,” and the response envelope may include a header that specifies a status of “0.” In addition, the response may include an info tag specifying a type “10” or type “11” and a value for the requested UserTag within a nested data tag. In contrast, if an error had occurred in connection with the request, the response returned by the print services directory service 304 may have indicated any HTTP status of other than “200,” “201,” “401,” or “404,” and the response envelope may have included a header specifying a status of value “2”-“12” as well as message or optional message values.

At 312, client application 302 receives the identifier. In addition, at 314, client application 302 obtains an e-mail address for the user of client application 302. In some implementations, client application 302 may obtain the user's e-mail address in response to manually requesting the user to enter the user's e-mail address. In alternative implementations, client application 306 may obtain the user's e-mail address automatically, without requesting the user to manually enter the user's e-mail address, for example, by accessing a stored version of the user's e-mail address from memory accessible to the client application 302.

At 316, client application 302 issues a request to initiate activation of the identifier that is accompanied by the user's e-mail address. Continuing again with the HTTP request-response example, this request may include the HTTP request headers discussed above and take the form “GET at <BASE_URL>/auth/activate/<target email account>,” where <target email account> is the user's e-mail address. In addition, the request may include, as an input, a password field specifying a user-defined password to be used when fetching sensitive data (e.g., a print job history).

At 318, in response to receiving the request, print services directory service 304 generates an activation code for the identifier. Thereafter, print services directory service 304 sends the activation code to the user's e-mail address at 320 and issues a response to client application 302 indicating that the activation code has been sent to the user's e-mail address at 322. Continuing yet again with the HTTP request-response example, this response may indicate an HTTP status of “200” and have a response envelope with a header specifying a status of “0”. In addition, in some cases, the response envelope may include an optional message stating that the activation code has been issued. In contrast, if an error had occurred in connection with the request, the response may have indicated any HTTP status other than “200,” “201,” or “401.” For example, the response may have indicated an HTTP status of “403” with a header specifying a status of “12” if the UserTag is no longer valid. Alternatively, the response may have indicated an HTTP status of “403” with a header specifying a status of “14” if the request had requested activation of a UserTag that already has been activated and specified a target e-mail account other than the target e-mail account associated with the UserTag.

At 324, client application 302 receives the response from print services directory service 304 confirming that the activation code has been sent. Then, at 326, client application 302 obtains the activation code. For example, client application 302 may receive the activation code in response to requesting that the user obtain the activation code from the user's e-mail account and manually enter the activation code into the client application 302.

After obtaining the activation code, client application then issues, at 328, a request to complete activation of the identifier that is accompanied by identifier itself and the activation code. Continuing still with the HTTP request-response example, this request may include the HTTP request headers described above, including the UserTag header with the value provided by print services directory service 304, and take the form “POST at <BASE_URL>/auth/activate/.” In addition, the request may include an “Authenticate” HTTP header specifying the activation code (e.g., a Base64-coded UserTag:ActivationCode pair).

At 330, after receiving the request to complete activation of the identifier, print services directory service 304 determines that the identifier and the activation code are valid and activates the identifier in response. Then, at 332, print services directory service 304 issues a response confirming that the identifier has been activated. Continuing still with the HTTP request-response example, this response may indicate an HTTP status of “200” and have a response envelope specifying a status of “0”. In addition, the response may include one or more info tags specifying types of any values other than “10” or “11.” In contrast, if an error had occurred in connection with the request, the response may have indicated an HTTP status of “403” and have a response envelope with a header specifying a status of “12” if the UserTag and/or the activation code were invalid. In addition, the error response may include a message stating information about the cause of the error.

At 334, client application 302 receives the response confirming that the identifier has been activated. Thereafter, and as will be described in greater detail below, client application 302 may use the activated identifier to access and leverage services provided by the print services directory service. For instance, continuing with the HTTP request-response example, client application 302 may specify the value of the activated identifier provided by the print services directory service 304 as the UserTag value as a header in HTTP requests in order to access and leverage the services provided by the print services directory service.

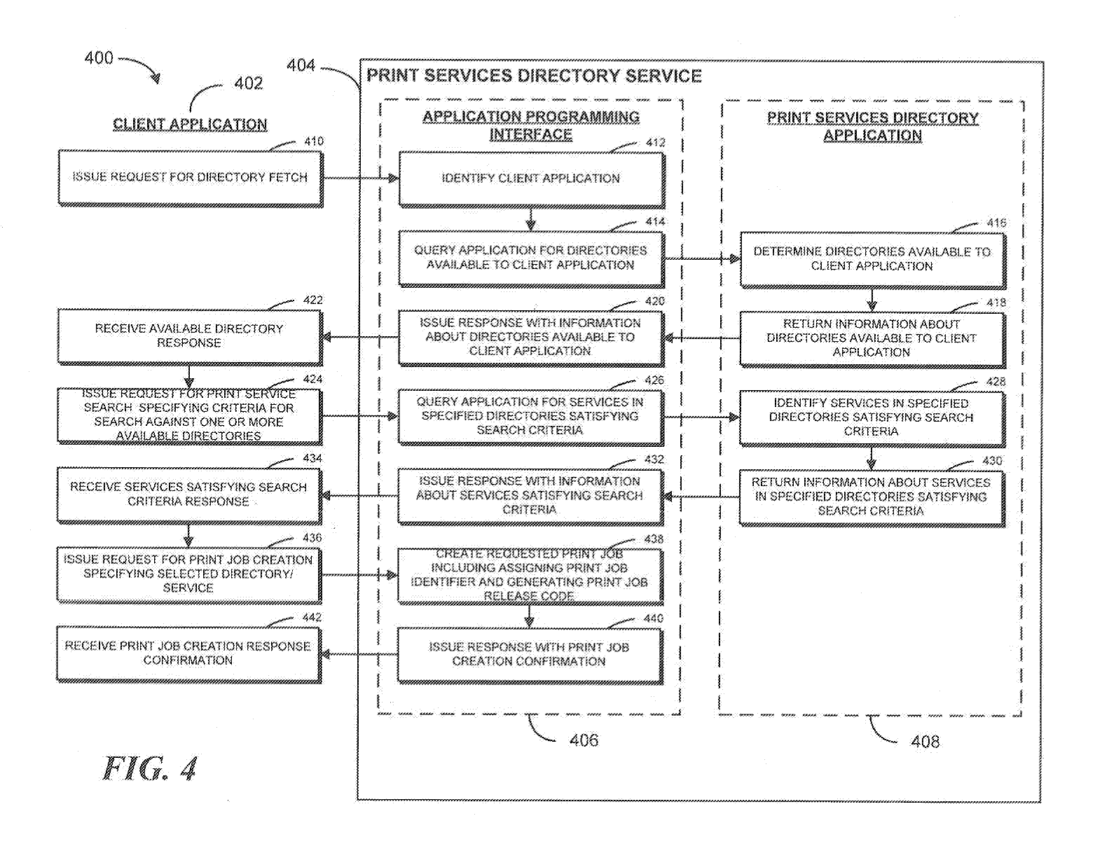

FIG. 4 is a flowchart 400 of an example of a process for identifying a print service. The process illustrated in the flowchart 400 of FIG. 4 may be performed by a client application executing on a computing device (e.g., mobile computing device 108 of FIG. 1) in conjunction with a print services directory service 404 (e.g., print services directory service 102 of FIG. 1) including an API 406 (e.g., API 116 of FIG. 1) and a print services directory application 408. In particular, the process illustrated in the flowchart 400 of FIG. 4 may be implemented by one or more processors of mobile computing device 108 and one or more processors 104 of the one or more computing devices on which print services directory service 102 is implemented as a consequence of executing instructions stored on computer-readable storage media accessible to mobile computing device 108 and instructions 106 stored on computer-readable storage media accessible to print services directory service 102, respectively.

At 410, client application 402 issues a request to fetch directories for different print services providers that are available to the client application.

Continuing yet again with the HTTP request-response example, the request may include the HTTP request headers described above, including the User-Agent header with the value identifying the requesting client application, and may take the form

“GET on <BASE_URL>/directory/.”

At 412, after receiving the request to fetch directories for different print services providers, API 406 identifies the requesting client application. For example, continuing with the HTTP request-response example, API 406 may identify the requesting client application based on the User-Agent header included within the request. Then, at 414, API 406 queries print services directory application 408 to identify which print services providers (e.g., which directories corresponding to print services providers) the requesting client application is authorized to access. This may involve translating the request received from client application 402 into a format expected by application 408. In response, at 416, print services directory application 408 determines which directories for print services providers are available to the requesting client application and returns, at 418, information about the directories for print services providers that are available to the requesting client application to API 406.

API 406 receives the information about the directories for print services providers that are available to the requesting client application from print services provider directory bank 408 and issues, at 420, a response to client application 402 that provides client application 402 with information about the directories for print services providers that are available to the client application 402. This may involve translating the response received from application 408 into an HTTP-compliant format expected by client application 402.

Continuing still with the HTTP request-response example, this response may indicate an HTTP status of “200” and have a response envelope with a header specifying a status of “0.” In addition, the response envelope body may include a directories collection with one or more directory objects specifying and providing information about the directories for print services providers that are available to the requesting client application 402, for example, with the following syntax:

<directories>

<directory...>...</directory>

</directories>

In contrast, if an error had occurred in connection with the request, the response may have indicated an HTTP status other than “200” or “201” and have a response envelope with a header and/or info tags providing information about the error.

The directory object mentioned above may be implemented in a variety of different ways. One particular example is described below. As outlined in Table 7 below, in this example, the directory object may accept a number of different attributes identifying information about the relationship between the print services provider corresponding to the directory and the print services provider directory service 404 and that may enable the client application to employ special corresponding behaviors and displays:

TABLE 7

| Attribute | Description |
|---|---|
| Version | Specifies a value for the version of the directory. |
| Premium | Specifies a bitmask indicating premium services to which the print |
| | services provider is entitled: |
| | 2: Client application is to offer one-click workflow for this |
| | print services provider (e.g., by providing an accelerator |
| | button such as accelerator buttons 219(a) and 219(b) of FIG. 2B); |
| | 4: Print services provided by this print services provider |
| | are to be listed first in search results; |
| | 8: Print services provided by this print services provider |
| | are to be listed second in search results; |
| | 16: Print services provided by this print services provider |
| | are to be listed third in search results; |
| | 32: Client application is to offer this print services provider |
| | on search filter that enables user to restrict searches to this print |
| | services provider; |
| | 64: Client application is to display designated icon |
| | corresponding to this print services provider when print services |
| | provided by this print services provider are displayed; and |
| | 128: Client application is to display designated branding |
| | content corresponding to this print services provider in |
| | connection with displaying service descriptions for this print |
| | services provider. |
| Id | Specifies an identifier for the directory to be used in connection |
| | with requests from the client application for transactions against |
| | the directory. |
| Type | Specifies a value for the type of the directory: |
| | “PARTNER” (e.g., commercial print services provider); |
| | “ENTERPRISE” (e.g., an internal enterprise directory for |
| | a client application that provides access to printers on an |
| | enterprise business network, for instance, for employees) |
| | “EPRINT” (e.g., a personal printer having a unique e-mail |
| | address and configured to receive print jobs via e-mails |
| | addressed to the unique e-mail address); |
| | “PPL” (e.g., a service provider that may not provide print |
| | services but that otherwise may be relevant to print services, for |
| | instance, a store that sells picture frames). |

In addition to the attributes described above, the directory object also may accept a number of different child objects. For example, the directory object may include a name child object (e.g., <name> . . . </name>) that specifies a name for the directory defined by the directory's corresponding print services provider and an icon child object (e.g., <icon> . . . </icon>) specifying a pointer (e.g., uniform resource identifier (URI) or uniform resource locator (URL)) to an icon/image corresponding to the directory.

The directory object also may include a capabilities collection (e.g., <capabilities> . . . </capabilities>) specifying different capabilities provided by the directory. In some implementations, these different capabilities may be specified by capability child objects (e.g., <capability> . . . </capability>) of the capabilities collection. Specifically, type attributes of the capability objects may be used to specify the capability type and the values accepted by the capability object (e.g., <capability type=“ . . . ”> . . . </capability>) as outlined in Table 8 below:

TABLE 8

| Type Name | Description | Values |
|---|---|---|
| FileTypeSupported | Indicates file types | Comma-separated list |
| | (e.g., file extensions) | of file extensions; |
| | supported by this | or Wildcard (*) indicates |
| | directory. | that all file types are |
| | | supported. |
| SelectableAttachments | Indicates whether | True if printing |
| | directory supports | attachments supported; |
| | printing e-mail | or |
| | attachments when | False if printing |
| | printing e-mail | attachments not |
| | messages. | supported. |
| PrintEmailBody | Indicates whether | True if printing e-mail |
| | directory supports | body supported; or |
| | printing e-mail | False if printing e-mail |
| | attachments when | body not supported. |
| | printing e-mail | |
| | messages. | |
| JobSettings | Indicates whether this | Bitmask: |
| | directory supports | 2: # of copies |
| | settings and, if so, what | 4: color/black and |
| | settings. | white |
| | | 8: print quality |
| | | 16: simplex/duplex |
| | | 32: media size |
| | | 64: orientation |
| ExcludeFileTypesBeforeSubmission | Indicates file types that | Comma-separated list of |
| | are not supported by | file extensions. |
| | this directory | |
| | irrespective of file types | |
| | indicated by | |
| | FIleTypesSupported | |
| | capability type. (E.g., | |
| | may be used to deny | |
| | printing of executables | |
| | or other system-wise | |
| | files.) | |
| SupportsRecommendation | Indicates whether this | True if print services |
| | print services provider | provider allows |
| | allows end-users to | recommendations; or |
| | make | False if print services |
| | recommendations. | provider does not allow |
| | | recommendations. |

In addition, the directory object also may include an accounts child object (e.g., <accounts> . . . </accounts>) that specifies an e-mail address for the print services provider that is configured to receive content to be printed by the print services provider irrespective of whether the client application requests that a particular service/location made available by the print services provider be used to print the content. For example, the accounts child object may have the following syntax:

<accounts>

<account> [e-mail address] </account>

</accounts>

The directory object also may include a disclaimers child object (e.g., <disclaimers> . . . </disclaimers>) that specifies text of (or that specifies a pointer to) a disclaimer relevant to the print services provider and/or a messages child object (e.g., <messages> . . . </messages>) that specifies text to be displayed, for example, describing services offered by this print services provider.

Referring again to FIG. 4, at 422, the client application 402 receives the response from API 406 specifying the directories available to the client application. The client application 402 then may use the information included within the received response to generate a display of information about the available directories to a user of the client application 402. For example, the client application 402 may use this information to populate a menu (e.g., drop-down filter menu 222 of FIG. 2B) with print services providers that are available to the client application 402.

At 424, the client application 402 then issues a print service search request that specifies one or more of the directories available to the client application 402 as well as search criteria to be searched against the specified directories. For example, this print service search request may be triggered by and include contextual information about a print request to be filled gathered by the client application as a result of user interaction with a print interface (e.g., print interface 210 of FIG. 2B).

Continuing yet again with the example of the HTTP request-response example, the request may include the HTTP request headers described above, including, for example, the X-ePrint-Location header specifying current location coordinates for the device on which the client application 402 is executing, and may take the form “GET at <BASE_URL>/service/search/<directory>,” where <directory> represents a string specifying the identifier for a directory to be searched. In some implementations, if the client application 402 desires to search all directories available to the client application 402 <directory> may be left uninformed or set to a value of “0.” In addition, in some implementations, the search criteria may be specified as GET parameters as outlined in Table 9 below:

TABLE 9

| Get Parameter | Description |
|---|---|
| Keywords | Specifies a comma-separated list of string tokens to |
| | be searched against the specified directories. |
| Latitude | Float value specifying a valid latitude. This data |
| | may take precedence over X-ePrint-Location latitude |
| | value if present. |
| Longitude | Float value specifying a valid longitude. This data |
| | may take precedence over X-ePrint-Location longitude |
| | value if present. |
| Accuracy | Accuracy of “latitude” and “longitude” |
| | GET parameters. This data may take precedence over |
| | X-ePrint-Location accuracy value if present. |
| maxresults | Value specifying a maximum number of results to |
| | retrieve. (E.g., Value may range from 1 to 100.) |
| | In some implementations, if not specified, default |
| | may be 50 services. |
| Segments | Specifies a comma-separated list of identifiers for |
| | segment for which search should be filtered. (E.g., |
| | may specify that retrieved results should be limited |
| | to print services located at airports.) |
| Profile | Specifies value of “full”, “intermediary” |
| | or “compact” corresponding to whether full, |
| | intermediary, or compact print service profiles should be |
| | retrieved. |

Referring again to FIG. 4, at 426, the API 406 receives the search request from the client application 402 and queries the print services directory application 408 for print services within the specified directories that satisfy the search criteria. This may involve translating the request received from the client application 402 into a format expected by the print services directory application 408.

In response, at 428, the print services directory application 408 identifies services in the specified directories that satisfy the search criteria. Then, at 430, the print services directory application 408 returns information about the services identified as satisfying the search criteria to the API 406.

The API 406 then receives this information from the print services directory application 408 and, at 432, issues a response to the client application that includes information about the print services identified as satisfying the search criteria. Continuing still with the HTTP request-response model, this response may indicate an HTTP status of “200” and have a response envelope with a header specifying a status of “0”. In addition, the response envelope body may include a services collection with one or more service objects (e.g., full, intermediary, or compact) specifying and providing information about the print services identified as satisfying the search criteria, for example, with the following syntax:

<services>

<service...>...</service>

</services>

In contrast, if an error had occurred in connection with the request, the response may have indicated an HTTP status other than “200” or “201” and have a response envelope with a header and/or info tags providing information about the error.

The service object mentioned above may be implemented in a variety of different ways. One particular example is described below. As outlined in Table 10 below, in this example, the service object may accept a number of different attributes specifying information about the print service that may enable the client application 402 to display information about the print service and to submit print jobs and otherwise communicate with the print service:

TABLE 10

| Attribute | Description |
|---|---|
| Id | Specifies an identifier for the specific print service |
| | within a directory. |
| Directory | Specifies an identifier for the directory to which the |
| | specified print service belongs. The combination of |
| | directory and Id identifiers may uniquely identify a |
| | print service. |
| Status | Specifies a value indicating whether the specified print |
| | service is accepting print requests. Values may be “online” |
| | or “offline.” |
| Top | Specifies a group index value related to how information |
| | about the specified print service is to be displayed and |
| | ordered. For example, values may range from 1-3, where |
| | services with a top value set to “1” should be displayed |
| | before services with top values set to “2” and “3.” |
| Hash | Specifies a value that enables print services directory |
| | service 404 to enforce validity of print service data if |
| | client application 402 applies caching of print service |
| | (e.g., “favorite” or “recent” lists). For example, the |
| | hash attribute may specify a computed value that combines |
| | data from the specified service. |
| Popularity | Specifies a scalar value that indicates a relative popularity |
| | of the specified print service among users. |
| Settings | Specifies settings supported by the specified print service. |
| | This value may be compatible with the job settings bitmask |
| | determined by this service's directory, but may state a |
| | different number of supported settings. The client application |
| | 402 may add (e.g., “AND”) this value with the directory mask |
| | as part of determining settings to display. |

In addition, the service object also may include service description children objects that specify additional information about the print service corresponding to the service object, including, for example, a name child object (e.g., <name> . . . </name>), a display child object (e.g., <display> . . . </display>), an icon child object (e.g., <icon> . . . </icon>), a brand child object (e.g., <brand> . . . </brand>), and a segment child object (e.g., <segment type=“ . . . ” icon=“ . . . ”> . . . </segment>). A name child object may specify a textual name for the print service and a display child object may specify a textual address for the print service or other information about the print service defined by the print services provider that provides the print service. Furthermore, an icon child object may specify a URL or other pointer to an icon corresponding to the print service and/or the print services provider that provides the print service, and a brand child object may specify a URL or other pointer to an icon for a brand corresponding to the print service and/or the print services provider that provides the print service. A segment object may specify the type of location where the service is operating (e.g., via a type attribute that accepts the values as defined in Table 11 below), an icon corresponding to the location type of the service via an icon attribute, and a textual description of the location type.

TABLE 11

| Type Attribute | |
|---|---|
| Value | Location |
| 0 | Generic/undefined |
| 1 | Hospitality (e.g., hotel, hostel, etc.) |
| 2 | Airport |
| 3 | Government agency, post office, public sector location |
| 4 | Library, museum |
| 5 | Education (E.g., university, school) |
| 6 | Private company, corporation, enterprise |
| 7 | Coffee shop, restaurant, kiosk, WiFi hotspot |
| 8 | Hospital, clinic |
| 9 | Convention center, conference, fair |
| 10 | Shopping center |

The service object also may include a geolocation child object that specifies information about the location of the print service, for example, with the following syntax:

<geolocation>

<latitude> . . . </latitude>
<longitude> . . . </longitude>
<distancerank> . . . </distancerank>
<distance> . . . </distance>

</geolocation>

In such implementations, the latitude and longitude objects may specify latitude and longitude coordinates, respectively, for the print service. In addition, based on information about the current location of the device on which the client application 402 is running provided in connection with the search request, the distancerank object may state information about how close the print service is to the device on which the client application 402 is running, for example, as outlined in Table 12 below, and the distance object may specify a distance between the print service and the device on which the client application 402 is running.

TABLE 12

| distancerank Object | |
|---|---|
| Value | Description |
| 0 | Irrelevant; too far |
| 1 | 10 meters or less |
| 2 | 100 meters or less |
| 3 | 500 meters or less |
| 4 | 1000 meters or less |
| 5 | 5000 meters or less |

The service object also may include a connection child object specifying one or more content transfer methods the print service supports for accepting print jobs (in some cases in addition to the HTTP upload method described below), for example, with the following syntax:

<connection>

<type> . . . </type>
<data> . . . </data>

</connection>

When the type child object within the connection object specifies a value of “0,” the print service may support e-mail submissions of print jobs. In such cases, the data object may specify an e-mail address for the print service to which print jobs may be sent. When the type child object within the connection object specifies a value of “1,” the print service may support HTTP upload submissions of print jobs. In such cases, the data object may specify a list of key/value pairs for the client application 402 to include in print job submission requests.

The service object also may include a company child object that specifies details about the print services provider that provides the specified service, for example, having the following syntax:

<company>

<name> . . . </name>
<department> . . . </name>
<organization> . . . </organization>
<logo> . . . </logo>

<company>

In addition, the service object also may include a print job release child object that specifies details related to how a user picks up a fulfilled print job, for example, having the following syntax:

<release>

<type id=“. . .” icon=“. . .”> . . . </type>
<term id= “. . .” icon= “. . .”> . . . </term>
<payment id=“. . .” icon=“. . .”> . . . </payment>

</release>

In such implementations, the id attribute of the type child object may specify information about how the print service releases print jobs and may accept the values outlined in Table 13 below; the id attribute of the term child object may specify information about the type of terminal the print service uses to fulfill print jobs and may accept the values outlined in Table 14 below; and the id attribute of the payment child object may specify forms of payment accepted by the print service and may accept the bitmask values outlined in Table 15 below:

TABLE 13

| Release Type | |
|---|---|
| Attribute Value | Release Type |
| 0 | Documents may be printed automatically and without |
| | user intervention. |
| 1 | A release code may be required to release documents. |
| 2 | User credentials (e.g., login/password) may be required |
| | to release documents. |
| 3 | Manual release (e.g., a service representative may be |
| | required to release documents). |

TABLE 14

| Terminal Type | |
|---|---|
| Attribute Value | Terminal Type |
| 0 | PC Station |
| 1 | Standalone kiosk or panel |
| 2 | Regular printer |
| 3 | Printer with control panel interaction |
| 4 | Store/service representative |

TABLE 15

| Payment Type | |
|---|---|
| Attribute Value | Accepted Payment Type |
| 0 | Not specified |
| 1 | Credit card |
| 2 | Debit card |
| 4 | Cash |
| 8 | Coupons, promotional cards |
| 16 | Pre-paid account, contract |

The service object also may include one or more sections children objects specifying additional information about the print services, for example, having the following syntax:

<sections>

<section type=“. . .” title=“. . .” icon=“. . .”>

<tag label=“. . .”>. . .</tag>
.
.
.

</section>
.
.
.

</sections>

Sections objects may include any kind of data formatted as a collection of section and tag children objects. For example, section objects may specify a type and title for the print service that may enable client application 402 to display different icons and other visuals related to the print service. In addition, section tags also may specify a label along with data. In some implementations, a type attribute in a section object may specify values as outlined in Table 16 below:

TABLE 16

| Type Attribute | |
|---|---|
| Value | Description |
| MESSAGE | Assorted data |
| ADDRESS | Address or location data |
| OPERATION | Operation hours or other operation-related |
| | information |
| ORGANIZATION | Extended organization and company information |
| PRICING | Extended pricing information |
| TRAVEL | Helpful information for tourists and travelers |
| | (e.g., languages spoken) |
| IMPORTANT | Urgent or important alerts for customers |
| CAPABILITIES | Service or device capabilities (e.g., duplexing, |
| | large format printing, etc.) |

In the case where a print service is tied to a specific device, the service object may include a device child object specifying additional information about the specific device, for example, having the following syntax:

<device>

<color>. . .</color>
<modelname>. . .</modelname>
<type>. . .</type>

</device>

In such cases, the color object may specify a value of “yes” or “no” to indicate whether it provides color printing, the model name object may specify a free string value identifying the model name of the device, and the device type object may specify values as outlined in Table 17 below:

TABLE 17

| Device | |
|---|---|
| Type Value | Description |
| 0 | Regular enterprise printer |
| 1 | Regular Home/SMB printer |
| 2 | Secure Pull Print Queue |
| 3 | Personal printer with remote printing capabilities |

For enterprise businesses that utilize the print services directory service 404 to enable employees to print content from detached devices, the print services directory service 404 may extend the device object to allow multiple instances and to facilitate load balancing. For example, in such cases, the device object may include a network child object having the syntax below:

<device>

.
.
.
<network>

<host>. . .</host>
<hoststatus>. . .</hoststatus>
<contentaccount>. . .</contentaccount>

</network>

</device>

In such cases, a host child object within the network object may specify an alternate server, a host status child object within the network object may specify the status of the alternate server, and a content account child object may specify an alternate target e-mail account.

The service object also may include a links child object specifying links to relevant external data or applications, for example, having the syntax:

<links>

<link type=“. . .” data=“. . .”>. . .</link>
.
.
.

</links>

In such cases, the type attribute of a link object may specify values as outlined in Table 18 below:

TABLE 18

| Link Type | |
|---|---|
| Value | Description |
| Map | Indicates that data attribute may specify a URL to a |
| | mapping service. |
| Phone | Indicates that data attribute may specify a phone |
| | number (e.g., which may enable the client application |
| | to place a telephone call or invoke voice over Internet |
| | protocol (VoIP) applications). |
| Web | Indicates that data attribute may specify a URL. |

As discussed above, the search request issued by the client application 402 at 424 may specify that a “compact” service profile is to be retrieved. In such cases, the service object may be limited to a name object, a display object, and a geolocation object.

Client application 402 may use the information included in the services collection to generate a display of information about the print services identified as being relevant to the print request (e.g., print services selection menu 240 of FIG. 2C and/or print confirmation interface 260 of FIG. 2D).

Referring again to FIG. 4, at 436, the client application issues a request to create a print job specifying a selected service within a selected directory. In some cases, all of the content to be printed as part of the print job may be included within the request (e.g., as binary MIME multipart attachments). In other cases, some or none of the content to be printed may be included in the request and the request may indicate how the content to be printed ultimately will be transferred from client application 402. Continuing with the HTTP request-response example introduced above, this request may include the HTTP headers discussed above and take the form “PUT at <BASE_URL>/job/<directory>/<service id>,” where <service id> specifies the identifier for the selected service and <directory> specifies the identifier for the directory for the selected service.

In addition, in some implementations, additional information about the print job to be created may be specified as PUT parameters as outlined in Table 19 below:

TABLE 19

| Put | |
|---|---|
| Parameter | Description |
| Timestamp | Specifies time at device on which client application |
| | is running |
| Label | Specifies a label for the print job defined by the |
| | client application |
| Desc | Specifies a description for the print job defined by |
| | the client application |
| Accepted | Specifies a value indicating whether a user of the |
| | client application has accepted a disclaimer: |
| | 1: User actively accepted disclaimer |
| | 2: User accepted a disclaimer previously for future |
| | print jobs |
| Latitude | Specifies a latitude coordinate for the device on |
| | which the client application is running. Value may |
| | override a value specified in connection with the |
| | X-ePrint-Location attribute. |
| Longitude | Specifies a longitude coordinate for the device on |
| | which the client application is running. Value may |
| | override a value specified in connection with the |
| | X-ePrint-Location attribute. |
| Accuracy | Specifies a horizontal accuracy value for the |
| | location coordinates. Value may override a value |
| | specified in connection with the X-ePrint-Location |
| | attribute. |
| Hash | Specifies the hash data specified in the service |
| | object returned by the API corresponding to the |
| | selected service. |
| Filenames | Specifies a comma-separated list of content filenames |
| | expected to be part of the print job. |
| Delivery | Specifies a value indicating how content to be printed |
| | will be delivered to the selected print service for the |
| | print job: |
| | 0: Content will be sent via e-mail; |
| | 1: Content will be sent through future HTTP upload |
| | requests |
| | 2: Content is embedded in the current request's body |
| Source | When an e-mail is being printed, specifies the e-mail |
| | address for the account at which the e-mail was received. |
| Excludebody | When an e-mail is being printed, specifies that the body of |
| | the e-mail should not be printed. |
| Settings | Specifies a six-position, comma-separated list of values |
| | defining different settings for the print job being |
| | requested: |
| | Position 1: Number of Copies |
| | Accepted values: Values from 0-9, where “0” means |
| | no value has been specified; default value is “1” |
| | Position 2: Color/Black and White |
| | Accepted values: Values from 0-2, where “0” means |
| | no value has been specified, “1” means black and |
| | white, and “2” means color; default value is color |
| | Position 3: Print Quality |
| | Accepted values: Values from 0-3, where “0” means |
| | no value has been specified, “1” means draft quality, |
| | “2” means high quality, and “3” means normal |
| | quality; default value is high |
| | Position 4: Duplex |
| | Accepted values: Values from 0-2, where “0” means |
| | no value has been specified, “1” means single-sided, |
| | and “2” means duplex; default value is duplex |
| | Position 5: Media Size |
| | Accepted values: Values from 0-5, where “0” means |
| | no value has been specified, “1” means letter size paper, |
| | “2” means A4 size paper, “3” means Legal size paper, |
| | and “4” means photo size paper (e.g., 89 × 127 mm) |
| | Position 6: Orientation |
| | Accepted values: Values from 0-2, where “0” means |
| | no value has been specified, “1” means portrait, and “2” |
| | means “landscape” |
| Password | Specifies a user password corresponding to a user of the |
| | client application. |

In some implementations, a selected print service may not be configured to print certain types of file formats. Therefore, in such implementations, the print services directory service 404 may convert a file received from client application 402 into a format that is supported by a selected print service. For example, the file to be printed may be the body of an e-mail taking the form of an HTML document with in-line images, and the selected print service may not be configured to support printing of such a document. Therefore, the print services directory service 404 may convert the file to be printed to the portable document format (PDF) before transmitting the document to selected print service for printing. In implementations where some of the available print services may not be configured to support printing of all file types, additional parameters may be added to the “Filenames” PUT parameter. For example, an additional parameter may be added to the “Filenames” PUT parameter for a document indicating that the document needs to be converted to a certain format (e.g., PDF) before being communicated to the selected print service for printing.

Referring again to FIG. 4, at 438, the API 406 creates the print job requested by the client application 402 and, at 440, the API 406 issues a response to the client application 402 confirming that the requested print job has been created. Creating the print job may involve assigning an identifier for the print job, establishing a queue to which files can be submitted to be printed, and generating a release code to be used by the user of mobile device 200 to retrieve the printed documents from the print service.

Continuing yet again with the HTTP request-response example introduced above, this response may indicate an HTTP status of “201” and have a response envelope body that includes a jobs collection with a job object that specifies information about the print job created by the API 406, for example, having the following syntax:

<jobs>

<job id=“. . .” directory=“. . .” timestamp=“. . .”>

</jobs>

In contrast, if an error had occurred in connection with the request, the response may have indicated an HTTP status other than “200” or “201” and have a response envelope with a header and/or various status, message, or optional message objects providing information about the error.

The job object mentioned above may be implemented in a variety of different ways. One particular example is described below. In this example, the job object may accept a number of different attributes as outlined in Table 20 below:

TABLE 20

| Job Attribute | |
|---|---|
| Value | Description Identifier |
| id | Specifies an identified for the print job defined by |
| | the print services directory service. |
| Directory | Specifies the directory from which the print service |
| | was selected. |
| Timestamp | Specifies a timestamp corresponding to the time at |
| | which the print job was created. |

The job object also may include a source child object specifying information about the client application that requested the creation of the print job and the device on which the client application is running, for example, having the following syntax:

<source>

<application>. . .</application>
<device>. . .</device>

</source>

Within the source object, both the application child object and the device child object may be free strings identifying the client application and the device on which the client application is running, respectively.

The job object also may include a status child object specifying information about the current status of the print job, for example, having the following syntax:

<status>

<code>. . .</code>
<message>. . .</message>
<detailedmessage>. . .</detailedmessage>
<link data=“. . .”>. . .</link>

</status>

Within the status object, the code child object may different values as outlined in Table 21 below:

TABLE 21

| Code Value | Details |
|---|---|
| Created(1) | Print job has been created and accepts content to be |
| | printed through HTTP upload requests. |
| In Progress(2) | Print job has been created and some of the content to be |
| | printed already has been received. Accepts additional |
| | content to be printed through HTTP upload requests. |
| Processing(3) | All content to be printed has been received. |
| Ready(4) | Documents are ready to be retrieved. |
| Cancelled(10) | Print job has been cancelled by user. |
| Denied(11) | Print job was denied by print services directory service or |
| | print services provider. |
| Aborted(12) | Print job was aborted due to an error. |

In addition, the message and detailed message child objects may include free strings specifying information about the status of the print job while the link object may specify a link to a resource relevant to the status of the print job (e.g., a support web page).

When the print job creation request issued by client application 402 at 436 indicates that content to be printed may be delivered via e-mail, the job object also may include a sessionid child object specifying HTTP session information to be tagged to any e-mail delivering content to be printed to enable correlation of the e-mail and its associated content with the created print job, for example, having the following syntax:
<sessionid placement=“ . . . ” marker=“ . . . ”> . . . </sessionid>
   In such cases, the placement attribute may specify where the sessionid should be located in e-mails that are used to deliver content to be printed as outlined in Table 22 below:

TABLE 22

| Placement | |
|---|---|
| Attribute | |
| Value | Meaning |
| 1 | E-mail subject is to specify marker + sessionid + marker |
| 2 | marker + sessionid + marker is to be added to the body |
| | of the e-mail |
| 3 | A file named eprint_session.xml with MIME type |
| | application/xml and including a copy of the sessionid object |
| | is to be attached to the e-mail. |

The job object also may include a release child object specifying information required to retrieve the printed documents, for example, having the following syntax:

<release>

<type id=“. . .” icon=“. . .”>. . .<type>
<term id=“. . .” icon=“. . .”>. . .</term>
<payment id=“. . .″ icon= “. . .”>. . .</payment>
<code expiration=“. . .”>. . .</code>

</release>

The type, term, and payment child objects within the release object may be the same as defined above in Tables 13, 14, and 15, respectively. Meanwhile, the code child object may specify the release code required to retrieve the printed documents with the expiration attribute specifying the expiration date of the release code.

The job object also may include a content object specifying information about any content to be printed in connection with the print job that already has been received, for example, having the following syntax:

<content>

<files>

<file release=“. . .” status=“. . .” receivedat=“. . .” size=“. . .”
ranges=“. . .”>. . .</file>

</files>
<message>. . .</message>

</content>

In such implementations, a file object within a files collection may specify a specific file that already has been received in connection with the print job as well as information about the specific file via the accepted attributes outlined in Table 23 below:

TABLE 23

| File Attribute | |
|---|---|
| Value | Description |
| Release | Specifies a type of release for the printed document: |
| | Auto: document can be retrieved by the user (e.g., |
| | self-service at a kiosk, station, or printer) |
| | Desk: service representative required to retrieve |
| | printed document. |
| Status | Specifies whether request to print document has been |
| | accepted or denied or whether the document only has |
| | been partially received. |
| receivedat | Specifies a timestamp recording the time the document |
| | was received. |
| size | Specifies the size of the document. |
| Ranges | Specifies a comma-separated list of byte ranges for |
| | partially received files. |

The job object also may include a message object specifying a message from the print services provider that is relevant to the print job, for example, having the following syntax:

<messages>

<message>. . .</message>

</messages>

In addition, the job object also may include a services collection including a service object specifying information about the selected print service and/or a suggestions collection including one or more service objects specifying other print services provided by the print services provider that provides the selected service, for example, having the following syntax:

<services>

<service>

<name>. . .</name>
<display>. . .</display>
<geolocation>

<latitude>. . .</latitude>
<longitude>. . .</longitude>
<distancerank>. . .</distancerank>
<distance>. . .</distance>

</geolocation>
<links>

<link type=″. . .″ data=″. . .″>. . .</link>
.
.
.
</links>

</service>
<suggestions source=“. . .”>

<service>

<name>. . .</name>
<display>. . .</display>
<geolocation>

<latitude>. . . </latitude>
<longitude>. . . </longitude>
<distancerank>. . .</distancerank>
<distance>. . .</distance>

</geolocation>
<links>

<link type=“. . .” data=“. . .”>. . .</link>
.
.
.

</links>

</service>

</suggestions>

</services>

Service objects were described above and, therefore, are not described again here. The source attribute of a suggestions object may specify information about how the services specified within the suggestions object were identified as being recommendations. For example, if the source attribute specifies a value of “STORE,” the recommended services may have been identified based on proximity to the selected print service. Alternatively, if the source attribute specifies a value of “LBS,” the recommended services may have been identified based on proximity to the device on which client application 402 is running (e.g., based on location information provided with the print job creation request).

Referring again to FIG. 4, at 442, the client application 402 receives the response confirming the creation of the print job. The client application 402 then may use information specified within the response confirming creation of the print job to complete the print job, for example, by coordinating with the print services directory service 404 and/or the selected print service.

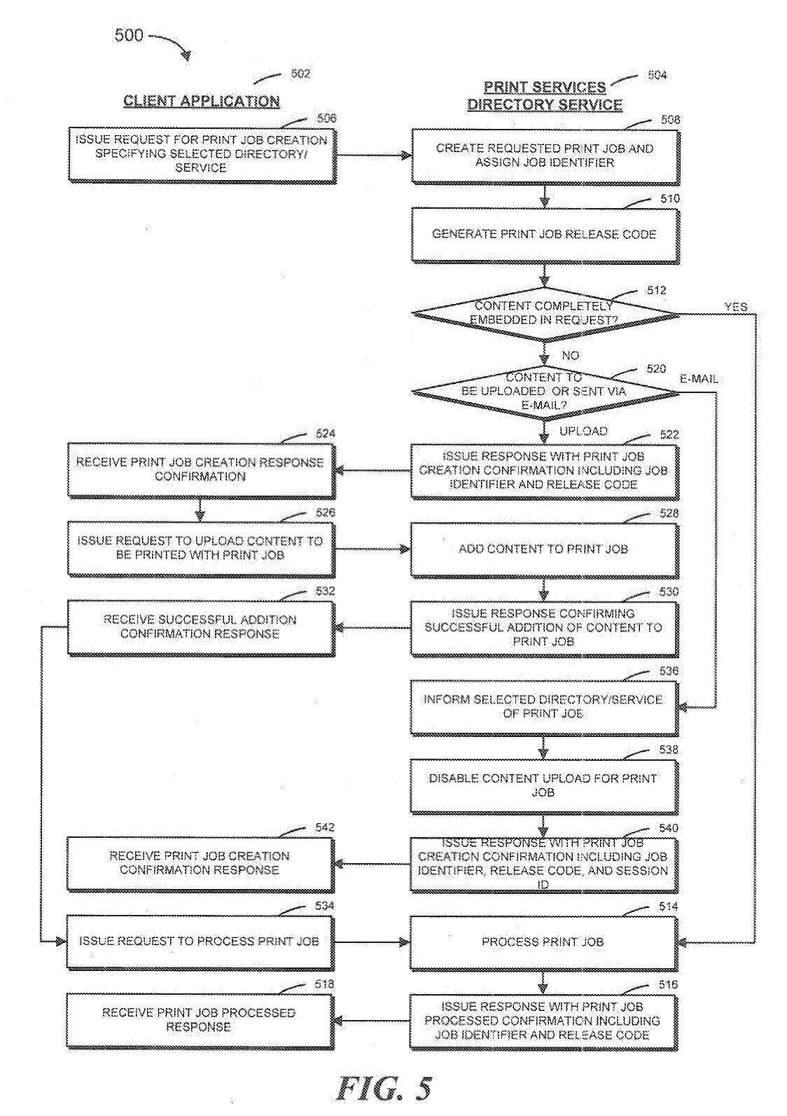

FIG. 5 is a flowchart 500 of an example of a process for completing a print job using a print service identified and selected, for example, as described above in connection with FIG. 4. The process illustrated in the flowchart 500 of FIG. 5 may be performed by a client application 502 (e.g., client application 402 of FIG. 4) executing on a computing device (e.g., mobile computing device 108 of FIG. 1) in conjunction with a print services directory service (e.g., print services directory service 102 of FIG. 1, print services directory service 404 of FIG. 4). In particular, the process illustrated in the flowchart 500 of FIG. 5 may be implemented by one or more processors of mobile computing device 108 and one or more processors 104 of the one or more computing devices on which print services directory service 102 is implemented as a consequence of executing instructions stored on computer-readable storage media accessible to mobile computing device 108 and instructions, including instructions 106, stored on computer-readable storage media accessible to print services directory service 102 respectively.

At 506, the client application issues a request for print job creation specifying a selected print service within a selected directory, for example, as described above in connection with 436 in FIG. 4. As described above, in some cases, this request may include all of the content to be printed in connection with the print job. In other cases, the request may indicate that some or all of the content to be printed will be delivered to the selected print service at a later time.

After receiving the request from the client application 502, the print services directory service 504, at 508, creates the requested print job and assigns a print job identifier, for example, as described above in connection with 438 in FIG. 4. In addition, at 510, the print services directory service 504 generates a release code for the print job, for example, as also described above in connection with 438 in FIG. 4.

At 512, the print services directory service 504 determines whether all of the content to be printed in connection with the print job is included within the request. In the event that the print services directory service 504 determines that all of the content to be printed is included with the request, the print services directory service 504 coordinates with the selected print service to process and complete the print job at 514. For example, the print services directory service 504 may transmit the file(s) to be printed in connection with the print job to the selected print service for printing.

Then, at 516, the print services directory service 504 issues a response to the client application 502 confirming that the print job has been processed and that includes the identifier for the print job and the release code assigned by the print services directory service 504. Continuing again with the HTTP request-response example introduced above, this response may indicate an HTTP status of “200” and have a response envelope body that includes various info objects specifying information related to the completed print job as well as a jobs collection with a job object that specifies information about the completed print job. In contrast, if an error had occurred in connection with the request, the response returned by the print services directory service 504 may have indicated any HTTP status other than “200” or “201” (e.g., 404 if the identifier for the print job specified in the request does not correspond to a valid print job) and the response envelope may have included info objects specifying messages about the error. The client application 502 then receives this response at 518.

Returning to 512, in the event that the print services directory service 504 determines that not all of the content to be printed is included within the request, the print services directory service 504 then determines, at 520, whether the request indicates that the content to be printed will be uploaded to the print services directory service 504 via additional HTTP requests or whether it will be transmitted to the selected print service via e-mail. In the event that the print services directory service determines that the content to be printed will be uploaded to the print services directory service 504 via additional HTTP requests, at 522, the print services directory service 504 issues a response to the client application 502 confirming that the print job has been created and specifying an identifier for the print job and a release code for retrieving the printed documents, for example, as discussed above in connection with 440 in FIG. 4

At 524, the client application 502 receives the response confirming the print job creation and, at 526, the client application 502 issues a request to upload content to be printed in connection with the print job to the print services directory service 504. Continuing with the HTTP request-response example introduced above, this request may include the HTTP headers discussed above including a cookie previously assigned to the client application 502 by the print services directory service 504 for tracking the HTTP session with the client application 502. In addition, the request may take the form “POST to <BASE_URL>/job/<job id>” where <job id> specifies the identifier for the print job assigned by the print services directory service 504. The content to be uploaded may be included within the request as a binary MIME multipart attachment.

Additional information about the content being uploaded to be printed in connection with the print job may be specified as POST parameters as outlined in Table 24 below:

TABLE 24

| POST | |
|---|---|
| Parameter | Description |
| Filenames | Specifies a comma-separated list of filenames for the |
| | content being uploaded. |
| Settings | Specifies a six-position, comma-separated list of values |
| | defining different settings for printing the content |
| | being uploaded: |
| | Position 1: Number of Copies |
| | Accepted values: Values from 0-9, where “0” means |
| | no value has been specified; default value is “1” |
| | Position 2: Color/Black and White |
| | Accepted values: Values from 0-2, where “0” means |
| | no value has been specified, “1” means black an |
| | white, and “2” means color; default value is color |
| | Position 3: Print Quality |
| | Accepted values: Values from 0-3, where “0” means |
| | no value has been specified, “1” means draft quality, |
| | “2” means high quality, and “3” means normal quality; |
| | default value is high |
| | Position 4: Duplex |
| | Accepted values: Values from 0-2, where “0” means |
| | no value has been specified, “1” means single-sided, and |
| | “2” means duplex; default value is duplex |
| | Position 5: Media Size |
| | Accepted values: Values from 0-5, where “0” means |
| | no value has been specified, “1” means letter size paper, |
| | “2” means A4 size paper, “3” means Legal size paper, |
| | and “4” means photo size paper (e.g., 89 × 127 mm) |
| | Position 6: Orientation |
| | Accepted values: Values from 0-2, where “0” means |
| | no value has been specified, “1” means portrait, and |
| | “2” means “landscape” |

Referring again to FIG. 5, the print services directory service 504 receives the request to upload the content to be printed (including the content to be printed), and, at 528, adds the uploaded content to the queue of content to be printed in connection with the print job.

Thereafter, the print services directory service 504 issues a response confirming that the content has been successfully added to the print job at 530. Continuing again with the HTTP request-response example introduced above, this response may indicate an HTTP status of “200” and have a response envelope body that includes various info objects specifying information related to the print job and/or the uploaded content as well as a jobs collection with a job object that specifies information about the print job as discussed above (e.g., information about the files currently associated with the print job). In contrast, if an error had occurred in connection with the request, the response returned by the print services directory service 504 may have indicated any HTTP status other than “200” or “201” (e.g., “404” if the identifier for the print job specified in the request does not correspond to a valid print job) and the response envelope may have included info objects specifying messages about the error.

At 532, the client application 502 receives the response confirming successful addition of the content to be printed to the print job. At that point, if the client application 502 desires to add additional content to be printed to the print job, 526, 528, 530, and 532 may be repeated. Otherwise, if all of the content to be printed already has been uploaded, at 534, client application 502, issues a request to process the print job. Continuing with the HTTP request-response example introduced above, this request may include the HTTP headers discussed above including a cookie previously assigned to the client application 502 by the print services directory service 504 for tracking HTTP session with the client application 502. In addition, the request may take the form “GET to <BASE_URL>/job/process/<job id>” where <job id> specifies the identifier for the print job assigned by the print services directory service 504.

The print services directory service 504 then receives the request to process the print job and, at 514, coordinates with the selected print service to process and complete the print job. For example, the print services directory service 504 may transmit the file(s) to be printed in connection with the print job to the selected print service for printing.

Then, at 516, the print services directory service 504 issues a response to the client application 502 confirming that the print job has been processed and including the identifier for the print job and the release code assigned by the print services directory service 504. Continuing again with the HTTP request-response example introduced above, this response may indicate an HTTP status of “200” and have a response envelope body that includes various info objects specifying information related to the completed print job as well as a jobs collection with a job object that specifies information about the completed print job. In contrast, if an error had occurred in connection with the request, the response returned by the print services directory service 504 may have indicated any HTTP status other than “200” or “201” (e.g., “404” if the identifier for the print job specified in the request does not correspond to a valid print job) and the response envelope may have included info objects specifying messages about the error.

The client application 502 then receives this response at 518.

Returning to 520, if the print services directory service 504 determines that content to be printed will be sent by the client application 502 to the selected print service via e-mail, the print services directory service 504 informs the selected print service (or print services provider) of the print job at 536. For example, the print services directory service 504 may transmit a message to the selected print service (or print services provider) with information relevant to the print job including, for example, the identifier assigned to the print job by the print service directory service 504, the release code assigned to the print job, and/or the files expected to be received in connection with fulfilling the print job.

Then, at 538, the print services directory service 504 may disable the capability to upload content for the specific print job to the print services directory service 504 so that content to be printed instead is to be e-mailed to the selected print service. In addition, at 540, the print services directory service 504 issues a response to the client application 502 confirming creation of the print job and including the identifier assigned to the print job, the release code for retrieving the printed documents, and the session identifier to be tagged to e-mails sent by the client application 502 to the selected print service in order to communicate files to be printed to the selected print service, for example, as discussed above in connection with 440 in FIG. 4. The client application 502 then receives the response from the print services directory service 504 at 542 and uses information included within the response (e.g., e-mail address for selected print service, job identifier, and sessionid) to generate and send one or more e-mails to the selected print service with the content to be printed by the print service.

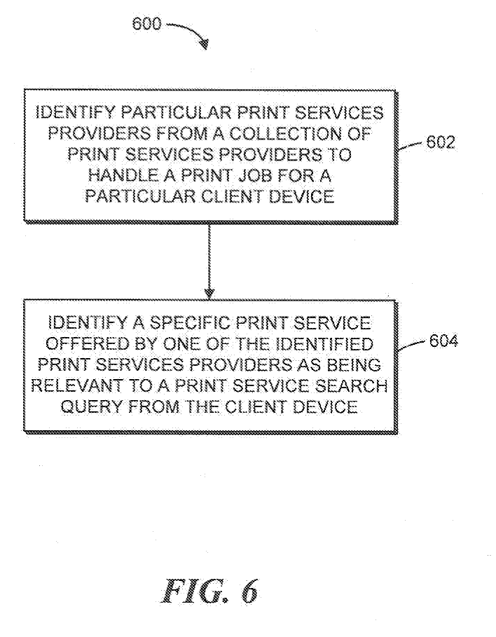

FIG. 6 is a flowchart 600 of an example of a process for identifying a relevant print service. The process illustrated in the flowchart 600 of FIG. 6 may be performed a print services directory service (e.g., print services directory service 102 of FIG. 1). In particular, the process illustrated in the flowchart 600 of FIG. 6 may be implemented by one or more processors 104 of the one or more computing devices on which print services directory service 102 is implemented as a consequence of executing instructions 106 stored on computer-readable storage media accessible to print services directory service 102.

At 602, particular print services providers are identified from among a collection of different print services providers to handle a print job for a particular client device. As discussed above, the identification of these print services providers may be based on an application executing on the client device, the client device itself, and/or an identify of a user of the client device. After identifying these print services providers, information about the identified print services providers may be transmitted to the particular client device. Thereafter, the particular client device may issue a search query for a print service that is relevant to a print job it desires to have completed. In response, at 604, a specific print service offered by one of the identified print services providers is identified as being relevant to the search query from the client device.

A number of implementations have been described. However, additional features are within the scope of this disclosure. For example, in some implementations, a document to be printed may be transmitted from a computing device to a print service identified and selected according to techniques described herein using near field communication (NFC) technologies.

A number of methods, techniques, systems, and apparatuses have been described. The described methods, techniques, systems, and apparatuses may be implemented in digital electronic circuitry or computer hardware, for example, by executing instructions stored in computer-readable storage media.

Apparatuses implementing these techniques may include appropriate input and output devices, a computer processor, and/or a tangible computer-readable storage medium storing instructions for execution by a processor.

A process implementing techniques disclosed herein may be performed by a processor executing instructions stored on a tangible computer-readable storage medium for performing desired functions by operating on input data and generating appropriate output. Suitable processors include, by way of example, both general and special purpose microprocessors. Suitable computer-readable storage devices for storing executable instructions include all forms of non-volatile memory, including, by way of example, semiconductor memory devices, such as Erasable Programmable Read-Only Memory (EPROM), Electrically Erasable Programmable Read-Only Memory (EEPROM), and flash memory devices; magnetic disks such as fixed, floppy, and removable disks; other magnetic media including tape; and optical media such as Compact Discs (CDs) or Digital Video Disks (DVDs). Any of the foregoing may be supplemented by, or incorporated in, specially designed application-specific integrated circuits (ASICs).

Although the operations of the disclosed techniques may be described herein as being performed in certain combinations and in a certain order, in some implementations, individual operations may be rearranged in a different order, combined with other operations described herein, and/or eliminated and the desired results still may be achieved. Similarly, components in the disclosed systems may be combined in a different manner and/or replaced or supplemented by other components and the desired results still may be achieved.

What is claimed is:

1. A computer-implemented method comprising:
receiving, from a first computing device and at a second computing device that is different and physically distinct from the first computing device, a request to identify print services providers for handling a print job, the request to identify print services providers including an identifier associated with the first computing device;
identifying, based on the identifier associated with the first computing device, a set of multiple different print services providers for handling a print job;
transmitting, to the first computing device, an indication of the multiple different print services providers for handling a print job;
receiving, from the first computing device and at the second computing device, a request to identify entities available to fulfill a print job, the request to identify entities available to fulfill the print job including search attributes and an indication of a selection of one or more of the multiple different print services providers as print services providers from which to identify entities available to fulfill the print job;
identifying, from among the one or more selected print services providers, one or more entities for fulfilling the print job as being relevant to the search attributes; and
transmitting, to the first computing device, an indication of the one or more entities for fulfilling the print job identified as being relevant to the search attributes.

2. The method of claim 1 wherein identifying a set of multiple different print services providers for handling a print job based on the identifier associated with the first computing device includes identifying, from a collection of multiple print services providers, a set of less than all of the collection of print services providers as print services providers that the first computing device is authorized to access.

3. The method of claim 1 further comprising:
assigning an identifier to the first computing device; and
transmitting the identifier to the first computing device, wherein receiving a request to identify print services providers that includes an identifier associated with the first computing device includes receiving a request to identify print services providers that includes the identifier assigned to the first computer device.

4. The method of claim 1 further comprising:
assigning an identifier to a user, wherein receiving a request to identify print services providers that includes an identifier associated with the first computing device includes receiving a request to identify print services providers that includes the identifier assigned to the user.

5. The method of claim 1 wherein identifying the set of multiple different print services providers for handling a print job includes:
identifying a print services provider that provides the ability to print content at multiple different printers located at multiple different physical locations; and
identifying a single printer for printing content at a single physical location.

6. The method of claim 1 wherein receiving a request to identify entities available to fulfill a print job that includes an indication of a selection of one or more of the multiple different print services providers as print services providers from which to identify entities available to fulfill the print job includes receiving a request to identify entities available to fulfill a print job that includes an indication of a selection of less than all of the multiple different print services providers.

7. The method of claim 1 wherein:
identifying the set of multiple different print services providers for handling a print job includes identifying a specific print services provider that provides the ability to print content at multiple different printers located at multiple different physical locations;
receiving a request to identify entities available to fulfill a print job that includes an indication of a selection of one or more of the multiple different print services providers as print services providers from which to identify entities available to fulfill the print job includes receiving a request to identify entities available to fulfill a print job that includes an indication of a selection of the specific print services provider as a print services provider from which to identify entities available to fulfill a print job; and
identifying, from among the one or more selected print services providers, one or more entities for fulfilling the print job as being relevant to the search attributes includes identifying a particular printer provided by the specific print services provider as an entity being relevant to the search attributes.

8. The method of claim 1 wherein:
identifying the set of multiple different print services providers for handling a print job includes identifying a specific print services provider having multiple different retail locations, at least a particular one of the retail locations having multiple different printers;
receiving a request to identify entities available to fulfill a print job that includes an indication of a selection of one or more of the multiple different print services providers as print services providers from which to identify entities available to fulfill the print job includes receiving a request to identify entities available to fulfill a print job that includes an indication of a selection of the specific print services provider as a print services provider from which to identify entities available to fulfill a print job; and
identifying, from among the one or more selected print services providers, one or more entities for fulfilling the print job as being relevant to the search attributes includes identifying the particular retail location of the specific print services provider as an entity being relevant to the search attributes.

9. The method of claim 1 wherein identifying, from among the one or more selected print services providers, one or more entities for fulfilling the print job as being relevant to the search attributes includes identifying one or more entities for fulfilling the print job that have attributes matching the search attributes.

10. The method of claim 1 further comprising:
receiving, from the first computing device and at the second computing device, a request to fulfill a specific print job using a specific one of the entities identified as being relevant to the search attributes; and
transmitting, to the specific entity, an indication of the request to fulfill the specific print job using the specific entity.

11. The method of claim 10 wherein transmitting an indication of the request to fulfill the specific print job using the specific entity includes transmitting an indication of the request to fulfill the specific print job to an application programming interface (API) exposed by the specific entity.

12. The method of claim 10 wherein:
receiving a request to fulfill a specific print job using a specific one of the entities identified as being relevant to the search attributes includes receiving, from the first computing device, content to be printed as part of fulfilling the specific print job; and
transmitting, to the specific entity, an indication of the request to fulfill the specific print job using the specific entity includes transmitting, to the specific entity, the content to be printed as part of fulfilling the specific print job.

13. The method of claim 10 further comprising transmitting, to the first computing device, an e-mail address corresponding to the specific entity for submitting content to be printed as part of fulfilling the specific print job, wherein transmitting, to the specific entity, an indication of the request to fulfill the specific print job includes transmitting, to the specific entity, an indication that the print job may be communicated to the specific entity via e-mail.

14. A system comprising:
one or more processors; and
a computer memory storage system storing instructions for implementing a print services directory application programming interface that, when executed by the one or more processors, cause the one or more processors to:
receive, from a client application executing on a remote electronic device, a print service search request including an identifier associated with the client application and specifying attributes to be used to identify print services that are potentially relevant to the print service search request;
convert the print service search request into a defined query format supported by a print services directory application, the converted query including identifying information associated with the client application and information to be used to identify print services that are potentially relevant to the print service search request;
receive, from the print services directory application, information identifying a particular print service that the print services directory application determined to be relevant to the print service search request and provided by a particular print services provider the client application is authorized to utilize;
convert the information identifying the particular print service into a defined format for responding to the print service search request; and
transmit the converted response identifying the particular print service to the client application executing on the remote electronic device.

15. A non-transitory computer-readable storage medium storing instructions that, when executed by a computing device, cause the computing device to:
identify, from among multiple different print services providers, particular print services providers for handling a print job for a particular client computing device, each of the different print services providers offering one or more print services for printing content; and
identify a specific print service offered by one of the particular print services providers as being relevant to a print service search query from the particular client computing device.
